(19) United States
(12) Patent Application Publication
(10) Pub. No.: US 2007/0016322 A1
(43) Pub. Date: Jan. 18, 2007

(54) Traceability management data creation method, traceability management data creation apparatus and traceability management data creation program storage medium

(75) Inventor: Keiichi Kataoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/509,625

(22) Filed: Aug. 25, 2006

Related U.S. Application Data
(63) Continuation of application No. PCT/JP05/08143, filed on Apr. 28, 2005.

(30) Foreign Application Priority Data
Apr. 30, 2004 (JP) 2004-135524

(51) Int. Cl. G06F 19/00

(52) U.S. Cl. 700/115; 700/226; 705/7

(57) ABSTRACT

A traceability management data creation apparatus for creating data for managing traceability for identifying parts, materials, products and unfinished products associated with one another in a kanban production system is provided with: a product record creation section which creates a product record including a product number of a product, a sequential number of a kanban accompanying the product, and a point in time of starting manufacture of the product, the product record being associated with one product or one group of the same kind of products; and a link record creation section which creates a link record which associates the product record of an unfinished product and the product record of a next-stage product manufactured with the use of the unfinished product as a material or a part.

### TECHNICAL FIELD

The present invention relates to a traceability management data creation method for creating data for management of traceability for identifying products, parts, materials and unfinished products associated with one another, in a kanban system, a traceability management data creation apparatus and a traceability management data creation program storage medium.

### BACKGROUND ART

A just-in-time production system has been widely known in which, by adopting a factory layout with respective production lines mutually linked, a necessary quantity of necessary articles are produced when necessary at the factory so that each part production line can provide parts for the next process in synchronization with the final assembly line.

In this just-in-time production system, a “kanban” has been devised and practically used so that unnecessary articles are not produced. A next process takes a required quantity shown on a “kanban” removed when parts were used, from the preceding process, and the preceding process produces the required quantity shown on the “kanban” removed when the parts were taken. In this way, the “kanban” is widely used as a tool for a carrying instruction by a next process and a production instruction by a preceding process.

There is a patent document which discloses an order management apparatus provided with reading means for reading order information about articles to be used in the next production from a medium (kanban) on which order information is recorded and which is used being circulated with articles; storage means for storing planning information which is about articles to be ordered as required for the next production, and which is determined in advance based on a production plan; checking means for determining whether or not the stored planning information and the read order information correspond to each other; and warning means for outputting that abnormality has been caused if it is determined by the checking means that the pieces of information do not correspond to each other, to a production process (see Patent document 1, for example).

In such a kanban system, an order instruction card, a so-called “kanban”, is used in order to produce a necessary quantity of necessary articles when necessary. The “kanban” is moved together with parts and effectively used as information to instruct production or carrying and as a visible management tool.

This kanban system, in which parts are provided from a preceding process to the next process just in time, is known as a production system which is extremely excellent from a viewpoint of inventory management.

[Patent Document 1]: Japanese Utility Mode Laid-Open No. 62-95852 (p. 2 and FIG. 1)

### DISCLOSURE OF THE INVENTION

### Problem to be Solved by the Invention

In the kanban system, parts are ordered based on a kanban on which a product number and a sequential number (a serial number indicating what number the kanban is in order) to identify a part to be ordered are shown, and the parts are delivered based on the kanban. In a conventional order management system, since an order slip is issued every time an order is placed, it is possible to manage a lot for each order. However, the kanban system does not have a concept of a lot number. Therefore, there is a problem that, in case of any abnormality being caused in a product later, it is not possible to go back to preceding processes to determine the cause of the abnormality.

Accordingly, there is proposed a method in which, in order to trace parts, a special parts list having a hierarchical structure is created to manage parts output history with the use of the parts list. However, additional works such as creation of the special parts list for order management are required. Furthermore, there is a problem that it is indispensable to make large-scale modification in such a parts list in cases of an introduction of a new product and the like, and a lot of man-hours are required for the modification works.

In consideration of the above situation, the present invention provides a traceability management data creation method for creating traceability management data which enables quick and easy identification of parts, materials and products associated with one another in a kanban system, a traceability management data creation apparatus and a traceability management data creation program storage medium.

### MEANS TO SOLVE THE PROBLEM

A traceability management data creation method of the present invention is a traceability management data creation method for creating data for management of traceability for identifying, from one product, products used for this one product as materials or parts and products using this one product as a material or a part, in a kanban production system in which, for each of unfinished products to be used for next-stage products as materials or parts and finished products, manufacture thereof is performed accompanied by a kanban used repeatedly and circularly for each of the products, wherein

a product record including a product number of a product, a sequential number of a kanban accompanying the product, and a point in time of starting manufacture of the product is created, the product record being associated with one product or one group of the same kind of products.

According to the traceability management data creation method of the present invention, since a product record including a product number, a sequential number and a manufacture start point in time is created as described above, it is possible to quickly and easily identify parts, materials and products associated with one another with the use of this product record.

The traceability management data creation method described above may be a method wherein

to a product record associated with an unfinished product, a point in time of starting use of the unfinished product for a next-stage product to be manufactured with the use of the unfinished product as a material or a product is further recorded.

If the traceability management data creation method of the present invention is configured as described above, a point in time of starting use for a next-stage product is recorded in a product record, and thereby it is possible to more quickly and easily identify parts, materials and products associated with one another with the use of this product record.

The traceability management data creation method described above may be a method wherein

in response to start of using an unfinished product associated with one product record, for a next-stage product to be manufactured with the use of the unfinished product as a material or a product, a link record is created to associate the product record of the unfinished product with the product record of the next-stage product.

If the traceability management data creation method of the present invention is configured as described above, a link record which associates the product record of an unfinished product with the product record of a next-stage product with each other is created in response to start of using the unfinished product, and thereby it is possible to still more quickly and easily identify parts, materials and products associated with one another with the use of this link record.

The traceability management data creation method described above may be a method wherein

in response to end of manufacturing a product with which one product record is associated, a manufacture end point in time is recorded in the product record of the product.

If the traceability management data creation method of the present invention is configured as described above, a manufacture end point in time is recorded in the product record of a product in response to end of manufacturing the product, and thereby it is possible to still more quickly and easily identify parts, materials and products associated with one another with the use of this product record.

The traceability management data creation method described above may a method wherein

in response to start of manufacturing a next-stage product with which one product record is associated and which uses an unfinished product as a material or a part, a link record is created which associates the product record of the unfinished product with the product record of the next-stage product.

If the traceability management data creation method of the present invention is configured as described above, a link record which associates the product record of an unfinished product with the product record of a next-stage product with each other is recorded in response to start of manufacturing the next-stage product, and thereby it is possible to still more quickly and easily identify parts, materials and products associated with one another with the use of this link record.

The traceability management data creation method described above may a method wherein

information accompanying a product is recorded in association with the product record of the product.

If the traceability management data creation method of the present invention is configured as described above, information accompanying a product is recorded in association with the product record of the product, and thereby it is possible to still more quickly and easily identify parts, materials and products associated with one another with the use of this accompanying information.

A traceability management data creation apparatus of the present invention is a traceability management data creation apparatus for creating data for management of traceability for identifying, from one product, products used for this one product as materials or parts and products using this one product as a material or a part, in a kanban production system in which, for each of unfinished products to be used for next-stage products as materials or parts and finished products, manufacture thereof is performed accompanied by a kanban used repeatedly and circularly each of the products, the apparatus including:

a product record creation section which creates a product record including a product number of a product, a sequential number of a kanban accompanying the product, and a point in time of starting manufacture of the product, the product record being associated with one product or one group of the same kind of products; and

a link record creation section which creates a link record which associates the product record of an unfinished product and the product record of a next-stage product manufactured with the use of the unfinished product as a material or a part.

According to the traceability management data creation apparatus of the present invention, since a product record including a product number, a sequential number and a manufacture start point in time is created as described above, it is possible to quickly and easily identify parts, materials and products associated with one another with the use of this product record.

Here, the traceability management data creation apparatus described above may be provided with an accompanying information recording section which records information accompanying a product in association with the product record of the product.

If the traceability management data creation apparatus of the present invention is configured as described above, it is possible, by the accompanying information recording section which records information accompanying a product in association with the product record of the product, to more quickly and easily identify parts, materials and products associated with one another with the use of the accompanying information.

The traceability management data creation program storage medium of the present invention is

a traceability management data creation program storage medium storing a traceability management data creation program which is executed in an information processor for executing programs and which causes the information processor to operate as a traceability management data creation apparatus for creating data for management of traceability for identifying, from one product, products used for this one product as materials or parts and products using this one product as a material or a part, in a kanban production system in which, for each of unfinished products to be used for the next-stage products as materials or parts and finished products, manufacture thereof is performed accompanied by a kanban used repeatedly and circularly for each of the products, the traceability management data creation program storage medium storing the traceability management data creation program which causes the information processor to operate as the traceability management data creation apparatus including:

a product record creation section which creates a product record including a product number of a product, a sequential number of a kanban accompanying the product, and a point in time of starting manufacture of the product, the product record being associated with one product or one group of the same kind of products; and

a link record creation section which creates a link record which associates the product record of an unfinished product and the product record of a next-stage product manufactured with the use of the unfinished product as a material or a part.

According to the traceability management data creation program stored in the traceability management data creation program storage medium of the present invention, it is possible to easily form a traceability management data creation apparatus which enables quick and easy identification of parts, materials and products associated with one another with the use of a product record, in an information processor.

Here, the traceability management data creation program storage medium described above may store a traceability management data creation program which causes the information processor to operate as the traceability management data creation apparatus further including an accompanying information recording section which records information accompanying a product in association with the product record of the product.

If the traceability management data creation program stored in the traceability management data creation program storage medium of the present invention is configured as described above, it is possible to easily form, in the information processor, the traceability management data creation apparatus further including the accompanying information recording section which records information accompanying a product in association with the product record of the product.

According to the present invention, a product record including a product number of a product, a sequential number of a kanban accompanying the product, and a point in time of starting manufacture of the product is created, and the product record is associated with one product or one group of the same kind of products, is created as described above. Thereby, it is possible to quickly and easily identify products, parts and materials associated with one another without performing management with a special parts list or the like.

Transition to the system of the present invention is easy because the operation of the system is close to the operation of the conventional kanban system. Furthermore, since the kanban can be repeatedly used, the cost of issuing a kanban can be reduced.

Furthermore, since a special parts list and the like are not required, special additional works required in the case of introducing a new product are not required.

### BRIEF DESCRIPTION OF THE DRAWINGS

FIG. 1 is a schematic block diagram showing an embodiment of a traceability management data creation apparatus of the present invention;

FIG. 2 is a schematic diagram of an information processor in which the traceability management data creation apparatus of this embodiment is formed;

FIG. 3 is a conceptual diagram of a product record which is a basis of traceability management in an embodiment of the present invention;

FIG. 4 is a diagram showing another example of serial keys shown in FIG. 3;

FIG. 5 is a diagram showing an example of associating pieces of information with one another in an embodiment of the present invention;

FIG. 6 is a diagram showing another example of associating pieces of information with one another in an embodiment of the present invention;

FIG. 7 is a diagram showing an example of an operation of reading a kanban in an embodiment of the present invention;

FIG. 8 is a diagram showing a data formation process in an embodiment of the present invention;

FIG. 9 is a diagram showing a trace operation in an embodiment of the present invention;

FIG. 10 is a diagram showing a method of associating pieces of information with one another in an embodiment of the present invention;

FIG. 11 is a diagram showing a defect cause identification method and an influence range identification method using traceability management data in an embodiment of the present invention;

FIG. 12 is a diagram showing mutual relation among the traceability management data;

FIG. 13 is a diagram showing the flow of an operation of acquiring “kanban-kanban data” in this embodiment;

FIG. 14 is a part of a flowchart showing the flow of processing for acquiring “kanban-manufacture conditions/quality information/stamp-on-product data” in this embodiment;

FIG. 15 is a part of a flowchart showing the flow of processing for acquiring “kanban-kanban data” in this embodiment;

FIG. 16 is a diagram showing the flow of an operation of acquiring “kanban-manufacture conditions/quality information/stamp-on-product data” in this embodiment;

FIG. 17 is a flowchart showing the flow of an operation of acquiring “kanban-manufacture conditions/quality information/stamp-on-product data” in this embodiment;

FIG. 18 is a diagram showing the file structure of a kanban data management table in this embodiment;

FIG. 19 is a diagram showing the file structure of a kanban link management table in this embodiment;

FIG. 20 is a diagram showing association relation between product records of unfinished products and product records of next-stage products based on link records in this embodiment;

FIG. 21 is a diagram showing the file structure of a stamp-on-product data management table in this embodiment;

FIG. 22 is a diagram showing the file structure of a quality information data management table in this embodiment;

FIG. 23 is a diagram showing the file structure of a manufacture conditions data management table in this embodiment;

FIG. 24 is a diagram showing association relation between a product record and quality information data accompanying a product in this embodiment;

FIG. 25 is a diagram showing association relation between a product record, and stamp-on-product data and manufacture conditions data accompanying a product in this embodiment;

FIG. 26 is a diagram showing a procedure for identifying the cause of an abnormality with the use of the traceability management data of this embodiment;

FIG. 27 is a flowchart of trace processing performed when the cause of an abnormality is identified with the use of the traceability management data of this embodiment;

FIG. 28 is a diagram showing a procedure for identifying the range of influence of a defective article with the use of the traceability management data of this embodiment;

FIG. 29 is a flowchart of trace processing performed when the range of influence of a defect is identified with the use of the traceability management data of this embodiment;

FIG. 30 is a diagram showing an example of a trace operation for identifying the cause of an abnormality with the use of the traceability management data of this embodiment;

FIG. 31 is a diagram showing an example of a trace operation for identifying the range of influence with the use of the traceability management data of this embodiment; and

FIG. 32 is a diagram showing an embodiment of a traceability management data creation program of the present invention.

### BEST MODE FOR CARRYING OUT THE INVENTION

Embodiments of the present invention will be described with reference to drawings.

First, an embodiment of a traceability management data creation apparatus of the present invention will be described.

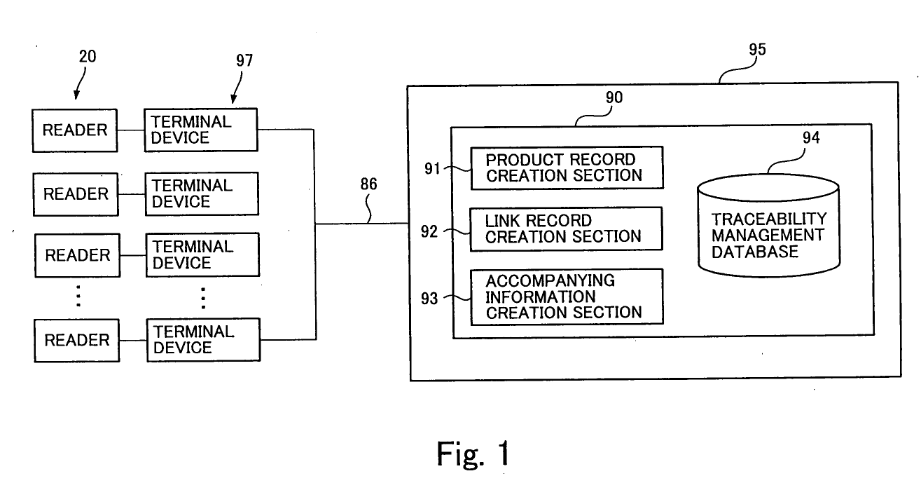

FIG. 1 is a schematic block diagram showing an embodiment of a traceability management data creation apparatus of the present invention.

As shown in FIG. 1, this traceability management data creation apparatus 90 is provided with a product record creation section 91 and a link record creation section 92, and it creates traceability management data for managing traceability in a kanban production system in which, each of unfinished products to be used for next-stage products as materials or parts and finished products is manufactured accompanied by a kanban used repeatedly and circularly.

Here, the traceability management data means data for identifying, from one product, products used for this one product as materials or parts and products using this one product as a material or a part.

This traceability management data creation apparatus 90 is formed on an information processor 95 together with a traceability management database 94 for storing traceability management data created by the traceability management data creation apparatus 90.

The traceability management database 94 is connected to multiple terminal devices 97 which are connected to the information processor 95 via a network 86. A reader 20 for reading a barcode recorded on a kanban is connected to each of these terminal devices 97.

The product record creation section 91 creates a product record including a product number of a product, a sequential number of a kanban accompanying the product and a point in time of starting manufacture of the product, the product record being associated with one product or one group of the same kind of products.

The link record creation section 92 creates a link record which associates the product record of an unfinished product with the product record of a next-stage product manufactured with the use of the unfinished product as a material or a part.

The traceability management data creation apparatus 90 of this embodiment is further provided with an accompanying information recording section 93.

The accompanying information recording section 93 records information accompanying a product in association with the product record of the product.

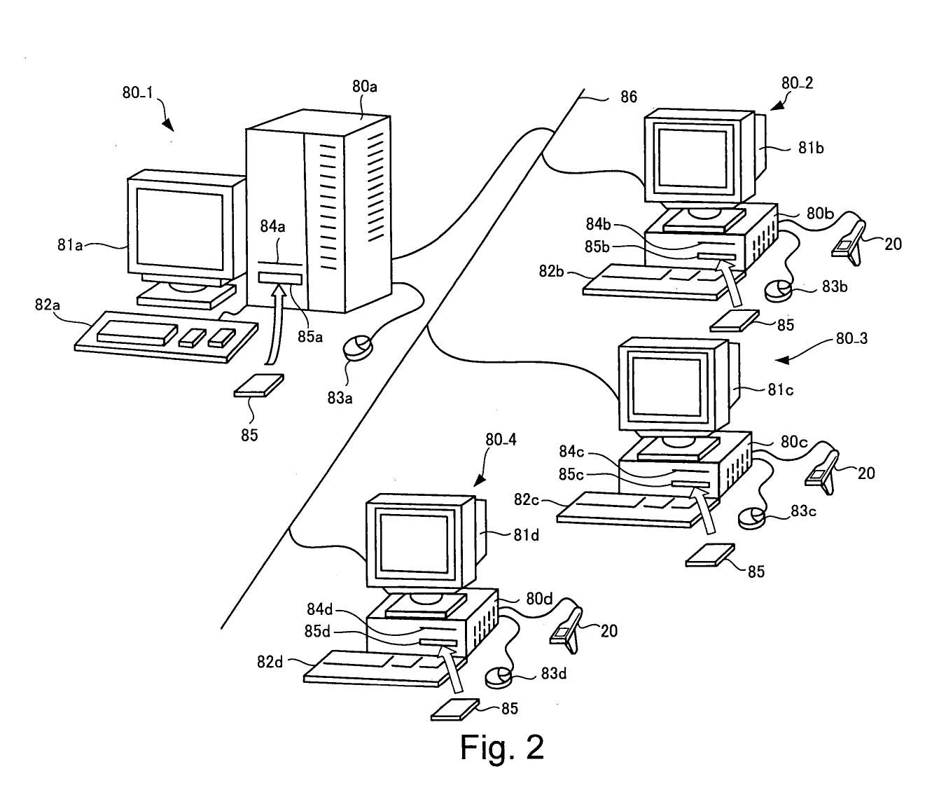

FIG. 2 is a schematic diagram of an information processor in which the traceability management data creation apparatus of this embodiment is formed.

In FIG. 2 is illustratively shown a file server 80_1 in which a database of traceability management data is constructed and multiple terminal devices 80_2, 80_3 and 80_4. The file server 80_1 and the terminal devices 80_2, 80_3 and 80_4 are connected to one another via the network 86.

As the computer system constructing each of the file server 80_1 and the terminal devices 80_2, 80_3 and 80_4, a high-speed and high-capacity computer system commonly referred to as a workstation or a so-called personal computer system is used.

The file server 80_1 in this embodiment corresponds to the information processor according to the present invention.

In a main body section 80a of the file server 80_1 is constructed, the traceability management database 94 (see FIG. 1) of traceability management data.

Each of the terminal devices 80_2, 80_3 and 80_4 is installed at a site of each manufacture process.

The file server 80_1 and the terminal devices 80_2, 80_3 and 80_4 are provided, respectively, with main body sections 80a, 80b, 80c and 80d which include a CPU, a main memory, a hard disk, a communication board and the like, display sections 81a, 81b, 81c and 81d which display an image or character strings on a display screen in response to an instruction from the main body sections 80a, 80b, 80c and 80d, keyboards 82a, 82b, 82c and 82d which are used to input an instruction from an operator into the file server 80_1 and the terminal devices 80_2, 80_3 and 80_4, and mice 83a, 83b, 83c and 83d by which the user specifies any position on the display screen to input an instruction corresponding to an icon or the like displayed at the position when the position is specified.

The reader 20 is connected to each of the terminal devices 80_2, 80_3 and 80_4. The reader 20 is a device for reading a barcode recorded on a kanban, and a stationary barcode reader, a portable hand or the like is used as the reader 20.

Recording of kanban information is not limited to a barcode. Any medium which can be attached to an actual article such as a product, a part and a material, for example, an IC tag may be used.

When viewed from the outside, the main body sections 80a, 80b, 80c and 80d have FD mounting ports 84a, 84b, 84c and 84d and MO mounting ports 85a, 85b, 85c and 85d through which a flexible disk (not shown) and an MO (magneto-optic disk) 85 is mounted, respectively. Inside them, a flexible disk drive unit and an MO drive unit for driving and accessing a flexible disk and an MO mounted through the mounting ports are also included, respectively.

Next, description will be made on a traceability management data creation method to be performed with the use of the above-described traceability management data creation apparatus.

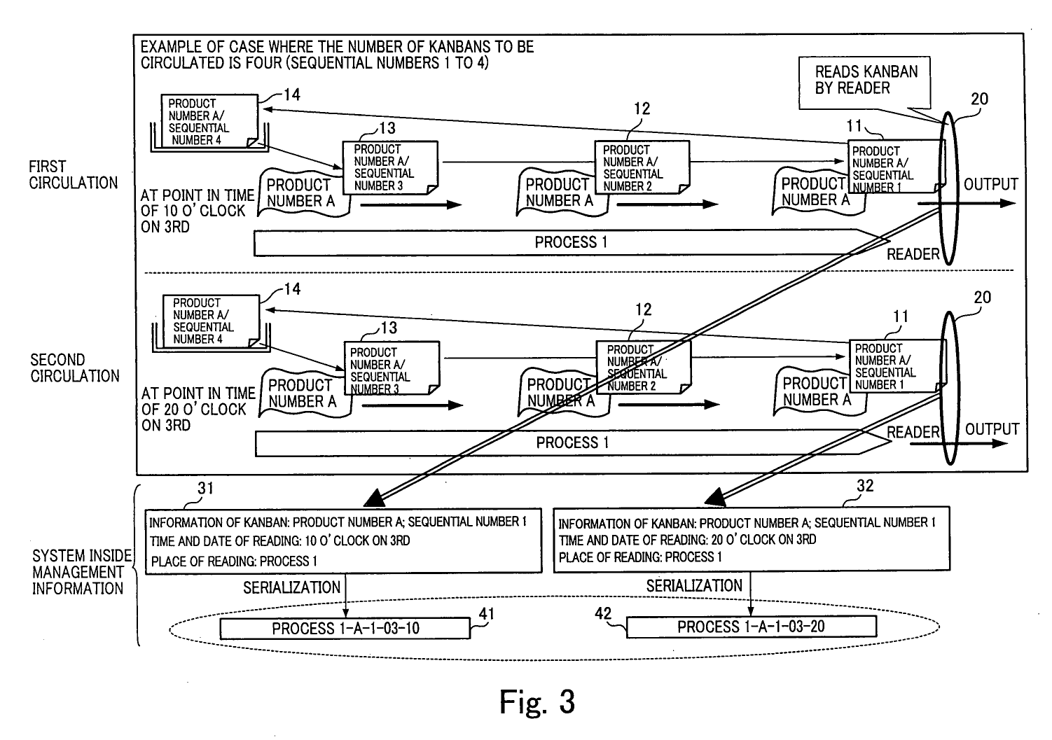

FIG. 3 is a conceptual diagram of a product record to be the basis of traceability management in an embodiment of the present invention.

In FIG. 3 is shown a process 1 in which a certain product is outputted after parts with a product number A are assembled thereto three times. In this process 1, four kanbans of part 11, 12 13 and 14 are repeatedly and circularly used.

Here, when a part A accompanying the kanban 11 of “product number A/sequential number 1” among the four kanbans is assembled to a product, the process 1 ends, and the product is outputted. At that point in time (10 o'clock on the 3rd), the kanban 11 is read by the reader 20. Next, when a part A accompanying the kanban 12 of “product number A/sequential number 2” is assembled to a product, the process 1 ends, and the product is outputted. At that point in time, the kanban 12 is read by the reader 20. Next, similarly, when parts A accompanying the kanban 13 of “product number A/sequential number 3” and the kanban 14 of “product number A/sequential number 4” are assembled to products, respectively, the process 1 ends, and the product is outputted. At the point in time when the assembly ends, the kanbans 13 and 14 are read by the reader 20.

After the first circulation of the four kanbans, when a part A accompanying the kanban 11 of “product number A/sequential number 1” is assembled to a product at 20 o'clock on the 3rd in the second circulation, the process 1 ends, and the product is outputted. At that point in time (20 o'clock on the 3rd), the kanban 11 is read by the reader 20.

Each of pieces of information 31 and 32 including by the product number and the sequential number read by the reader 20, the time when the kanban was read by the reader 20, and the like are serialized, and serial keys 41 and 42 are created and stored inside the system as management information. Accordingly, the serial keys 41 and 42 created in this way are unique keys as shown in the drawing, they can be identified from each other.

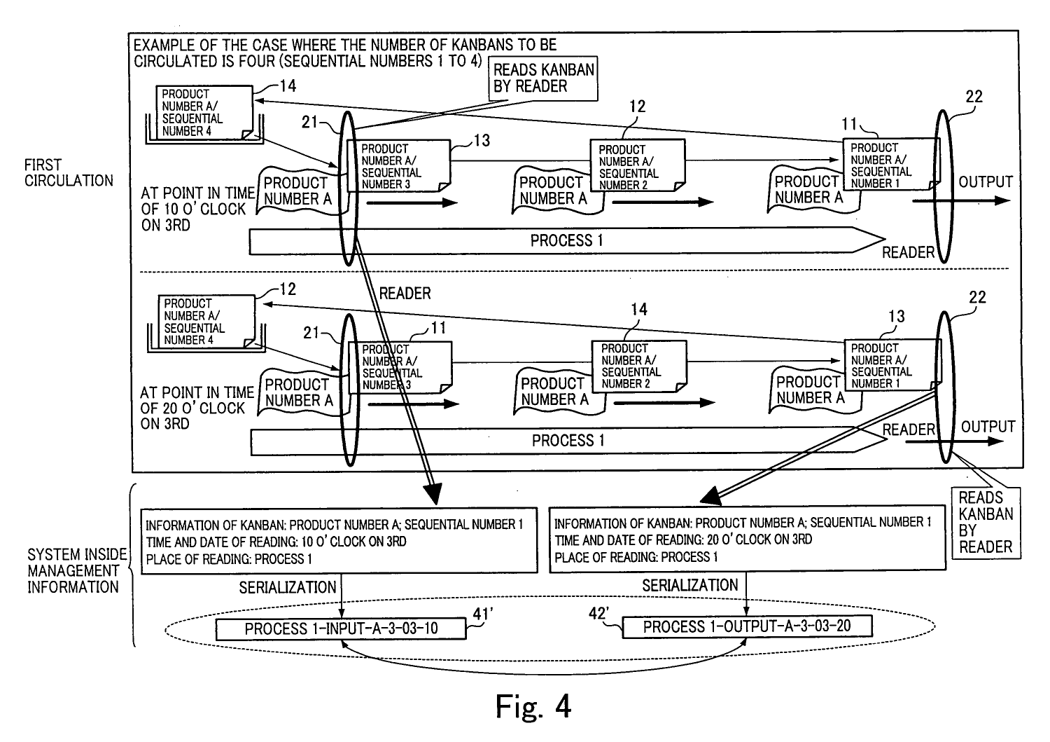

FIG. 4 is a diagram showing another example of the serial keys shown in FIG. 3.

In FIG. 4 is shown a management system in the case of reading a kanban at two points in time, the point in time of input and the point in time of output, in the process 1. In this system, separate readers 21 and 22 are provided so that a kanban can be read at each of the two reading places, the input and output points of the process.

Due to this configuration, serial keys 41′ and 42′ to which information at the respective reading places is added can be generated, and thereby, it is possible to associate an inputted part and an outputted part with each other inside the system. For example, in the example of FIG. 4, it can be determined that the kanban with the sequential number 3 read first at output after 10 o'clock is the kanban inputted at 10 o'clock.

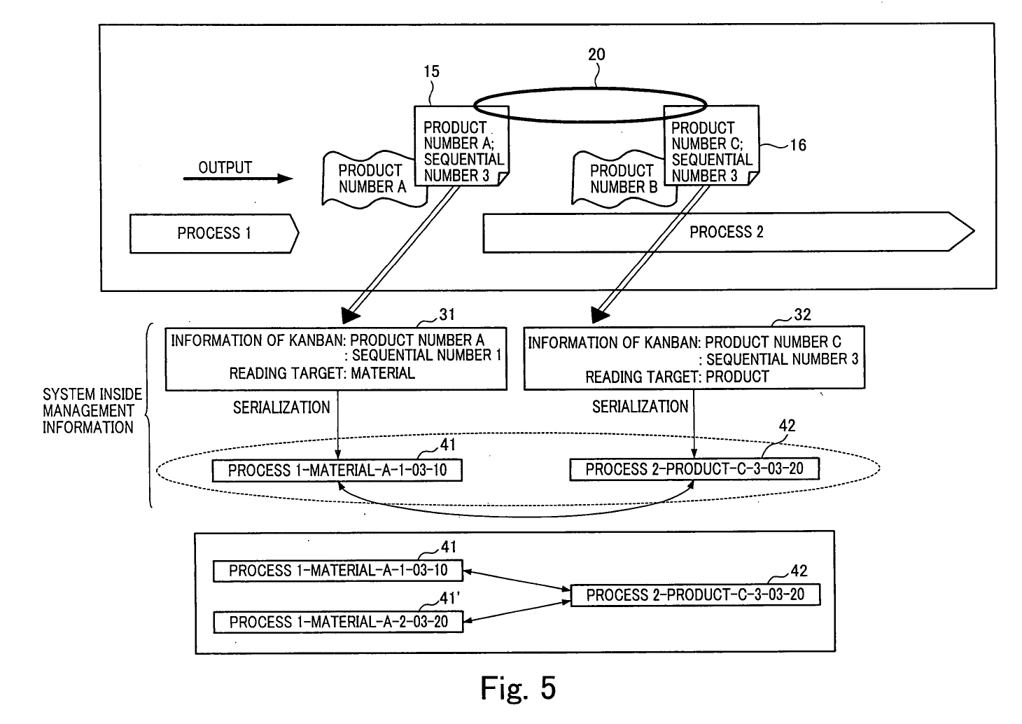

FIG. 5 is a diagram showing an example of associating pieces of information with one another in an embodiment of the present invention.

FIG. 5 shows that a material kanban 15 of “product number A/sequential number 1” outputted from the process 1 and inputted into a process 2 and a product kanban 16 of “product number C/sequential number 3” are read together by the reader 20. Information 31 and 32 created by being read by the reader 20 is serialized to create Serial keys 41 and 42, and the serial keys are stored inside the system as management information.

Thus, the associated serial keys 41 and 42 can be created, even when multiple processes are involved, and the product numbers of the kanbans of preceding and next processes are different from each other.

If the process 2 uses material of “product number A/sequential number 1” outputted from the process 1 and material of “product number A/sequential number 2”, two serial keys 41 and 41′ and the serial key 42 can be associated as shown in the drawing.

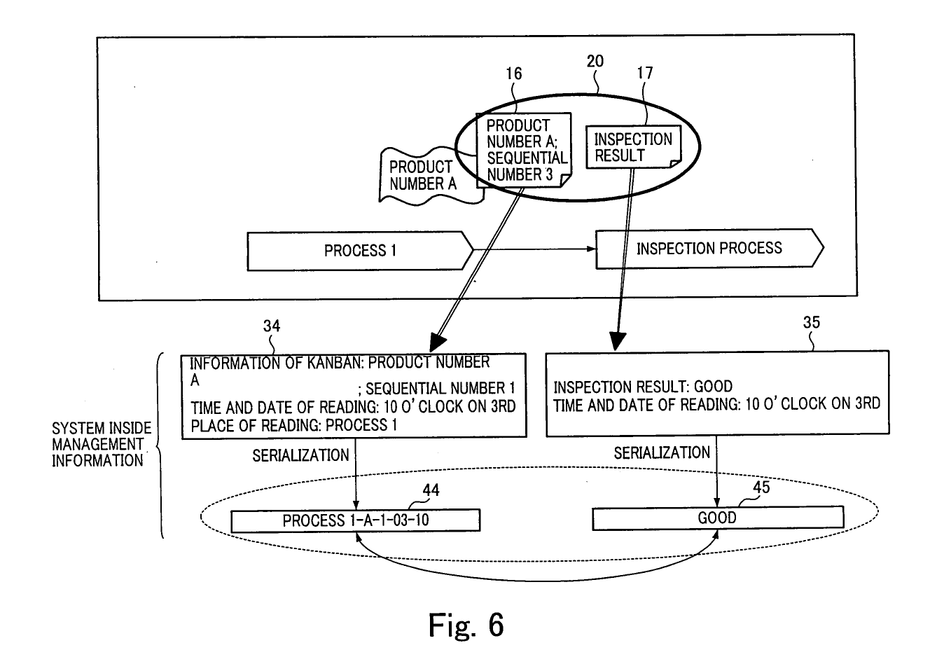

FIG. 6 is a diagram showing an other example of associating pieces of information with one another in an embodiment of the present invention.

In FIG. 6 is shown an example in which a kanban 16 of “product number A/sequential number 3” inputted from the process 1 to an inspection process is read by reader 20, and an inspection result 17 about the part is read by a reader or a hand scanner.

Information 34 of the kanban 16 read by the reader 20 or a hand scanner is serialized and stored inside the system as a serial key 44, and information 35 based on the inspection result 17 which has been read by a reader or a hand scanner is serialized and stored inside the system as a serial key 45.

Due to such a configuration, the serial key 44 and the serial key 45 can be associated with each other, and thereby, quality information about the part such as the inspection result can be freely retrieved from among management information.

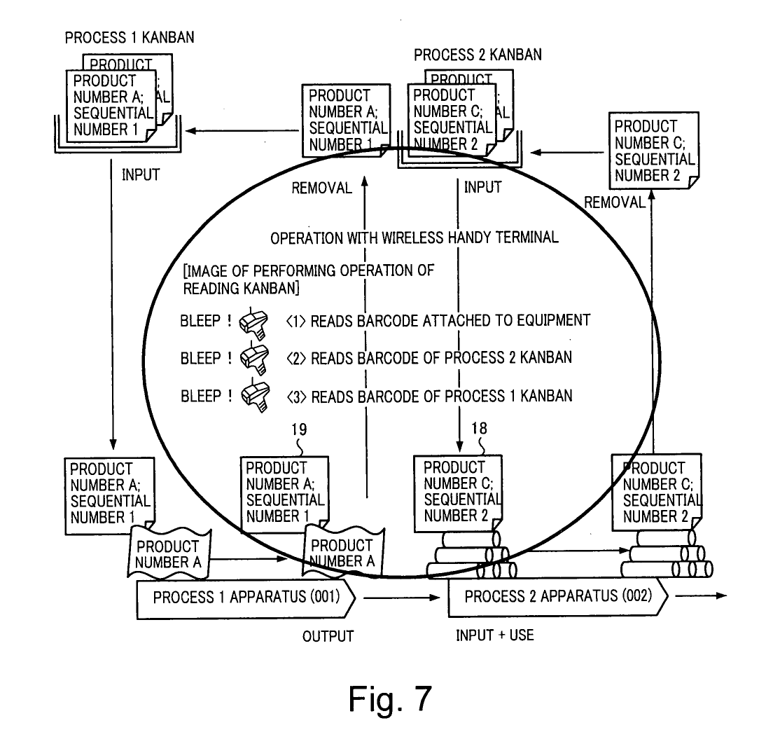

FIG. 7 is a diagram showing an example of an operation of reading a kanban in an embodiment of the present invention.

In FIG. 7 is shown an example in which a process 2 kanban 18 (“product number C/sequential number 2”) is inputted into an apparatus (002) of the process 2, and in this case, material of a process 1 kanban 19 (“product number A/sequential number 1”) is used as the material. In this kanban reading operation, an example of reading a barcode with a wireless handy terminal is shown.

This kanban reading operation is performed as follows:

(1) Reads the barcode attached to the equipment;

(2) Reads the barcode of the process 2 kanban 18; and

(3) Reads the barcode of the process 1 kanban 19.

Thus, it is read into the system that, in the process 2, “product number C/sequential number 2” is inputted into the equipment to be used: the apparatus (002), and “product number A/sequential number 1” is used as the material.

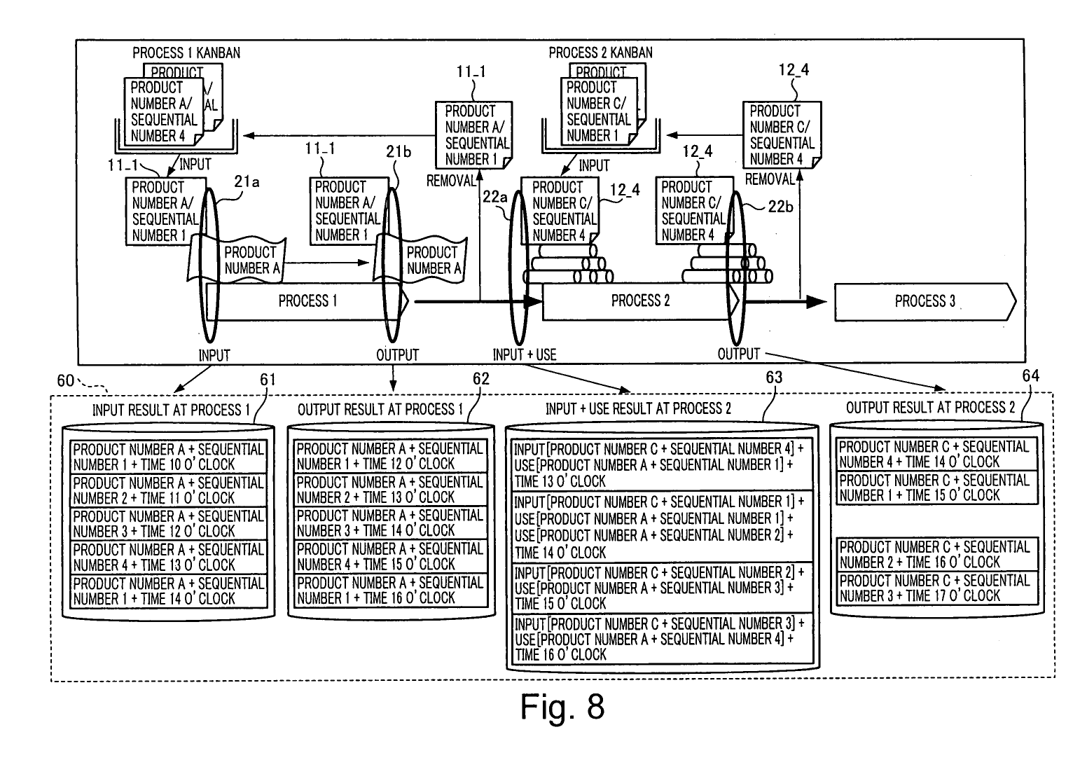

FIG. 8 is a diagram showing a data formation process in an embodiment of the present invention.

FIG. 8 shows a sequence of processes as follows. A part of product number A is inputted into the process 1, accompanying a process 1 kanban 11_1 of “product number A/sequential number 1”. When the process 1 ends, a product is outputted to the process 2, and the process 1 kanban 11_1 is removed. Then, a part of product number C is inputted into the process 2, accompanying a process 2 kanban 12_4 of “product number C/sequential number 4”. When the process 2 ends, the product is outputted to a process 3, and the process 2 kanban 12_4 is removed.

A reader 21a and a reader 22a are installed at input places of the processes 1 and 2, respectively, and a reader 21b and a reader 22b are installed at output places of the processes 1 and 2, respectively. Management information 60 as shown at the lower part of FIG. 8 is formed based on data obtained from these readers.

That is, the management information 60 includes a process 1 input result file 61 created based on the data obtained from the reader 21a, a process 1 output result file 62 created based on the data obtained from the reader 21b, a process 2 input+use result file 63 created based on the data obtained from the reader 22a, a process 2 output result file 64 created based on the data obtained from the reader 22b . . . .

Accordingly, since a serial key created through associating a product number, a sequential number and the time of reading with one another is stored as management information, it is possible to freely trace products, parts and materials associated with one another from both of upstream and downstream sides based on the information, as described below.

The serial key in this embodiment corresponds to the product record stated in the present invention. It includes a product number, a sequential number of a kanban accompanying the product and the point in time of starting manufacture of the product, and it is associated with one product or one group of the same kind of products.

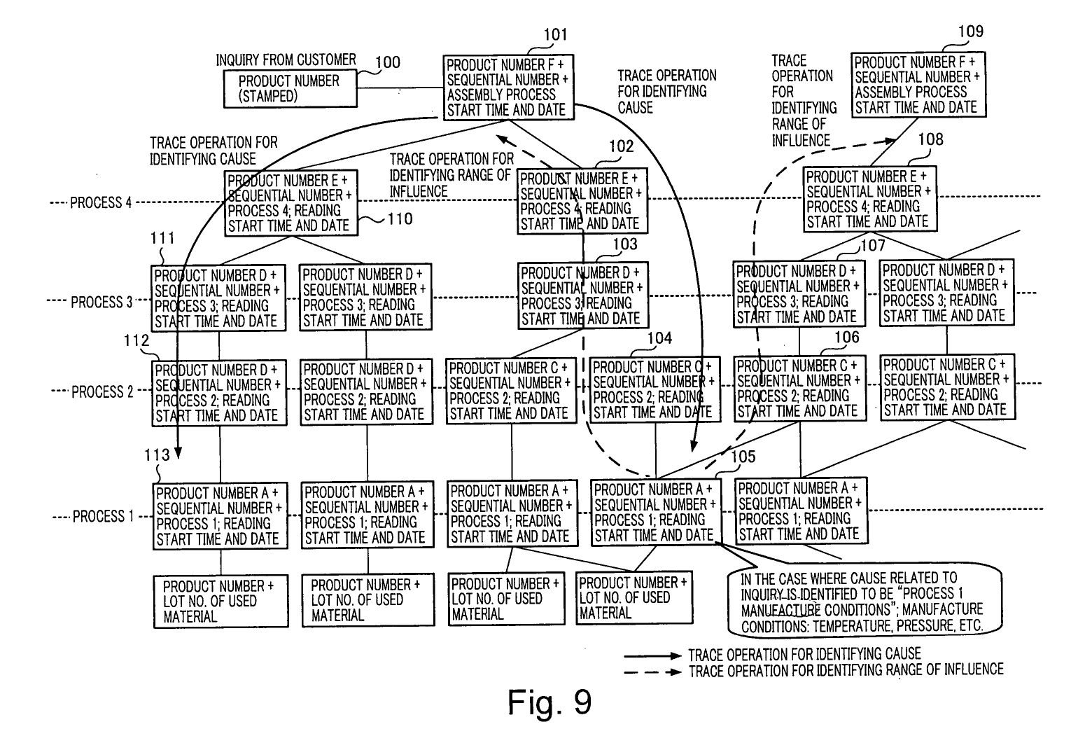

FIG. 9 is a diagram showing a trace operation in an embodiment of the present invention.

In FIG. 9 is shown multiple product records created from kanbans of respective processes 1 to 4, being associated with one another as a hierarchical structure, and is shown an example in which, based on inquiry by a customer, the product records are traced from the product number 100 stamped on the product, toward the preceding processes, and it is identified that the cause related to the inquiry is in “process 1 manufacture conditions”.

First, by searching the product records in FIG. 9 by going back from the process 4 toward the preceding processes, based on the product number 100, information 101, which is “product number F+sequential number+assembly process start time and date”, can be obtained. Then, with this information 101 as a start point, the trace operation is continued with the product number, the sequential number and the reading start time and date used as a key, and information 105, which is “product number A+sequential number+process 1 reading start time and date”, can be reached via information 102, 103 and 104. Thereby, the cause related to the inquiry can be identified to be in “process 1 manufacture conditions”, that is, the temperature and pressure during manufacture.

Furthermore, in the traceability management data creation method of this embodiment, it is possible, by continuing the trace operation toward next processes with the information 105 as a start point and with the product number, the sequential number and the reading start time and date as a key, to trace the range influenced by the cause of the defect and to reach information 109 via information 106, 107 and 108.

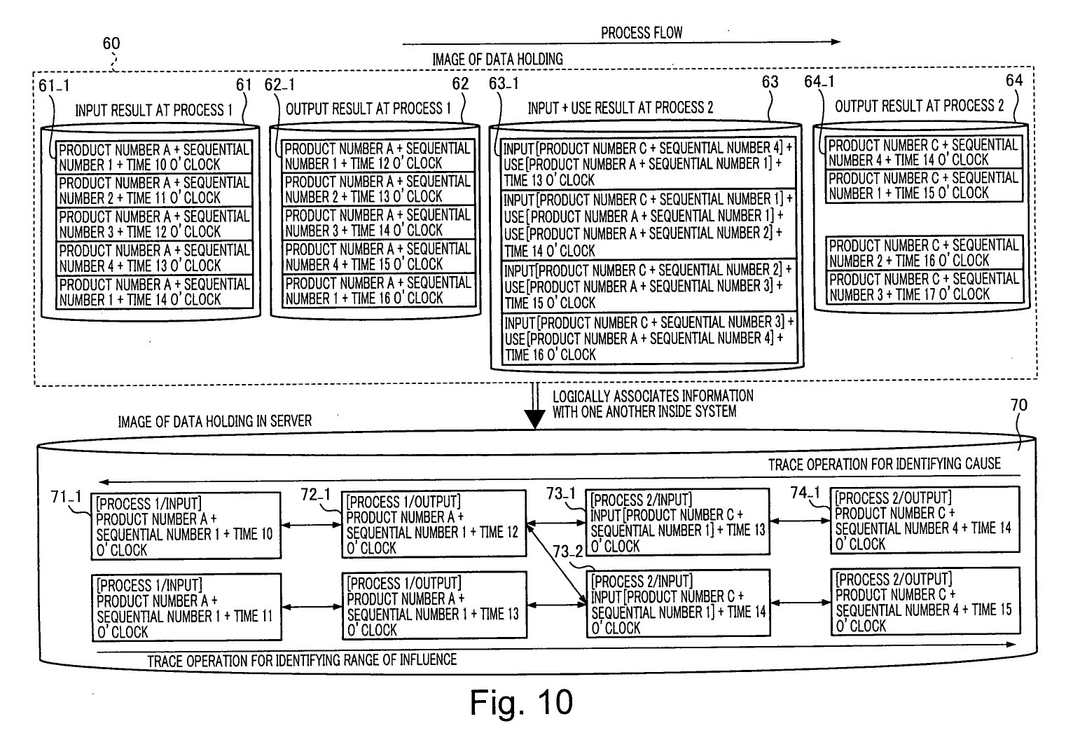

FIG. 10 is a diagram showing a method of associating pieces of information with one another in an embodiment of the present invention.

In FIG. 10, information is logically associated inside the system based on data stored in the management information database 60 (see FIG. 8) and is stored in a database in the file server 80_1 (see FIG. 2) as a form of an image of data holding 70 shown in FIG. 10.

For example, from input result data 61_1, which is “product number A+sequential number 1+time 10 o'clock”, in the process 1 input result file 61, output result data 62_1 which is “product number A+sequential number 1+time 12 o'clock”, in the process 1 output result file 62, input+use result data 63_1, which is “input [product number C+sequential number 4]+use [product number A+sequential number 1]+time 13 o'clock”, in the process 2 input+use result file 63, and output result data 64_1, which is “product number C+sequential number 4+time 14 o'clock”, in the process 2 output result file 64, process 1 input data 71_1 and process 1 output data 72_1 are associated with each other, the process 1 output data 72_1 and process 2 input data 73_1 are associated with each other, the process 2 input data 73_1 and process 2 output data 74_1 are associated with each other, and the process 1 output data 72_1 and the process 2 input data 73_2 are associated with each other.

By logically associating mutually related data with each other and storing it inside the system in a form of the image of data holding 70 as shown in FIG. 10, as described above, it is possible to identify a cause by performing trace from next processes to preceding processes with the use of this image of data holding 70. Furthermore, it is possible to identify the range influenced by the cause of a defect by performing trace from preceding processes to next processes with the use of this image of data holding 70.

The image of data holding 70 in this embodiment corresponds to the “data for managing traceability” stated in the present invention, and the “traceability” indicates the concept of “identifying, from one product, products used for this one product as materials or parts and products using this one product as a material or a part, in a kanban production system in which, for each of unfinished products to be used for next-stage products as materials or parts and finished products, manufacture is performed accompanied by a kanban used repeatedly and circularly.”

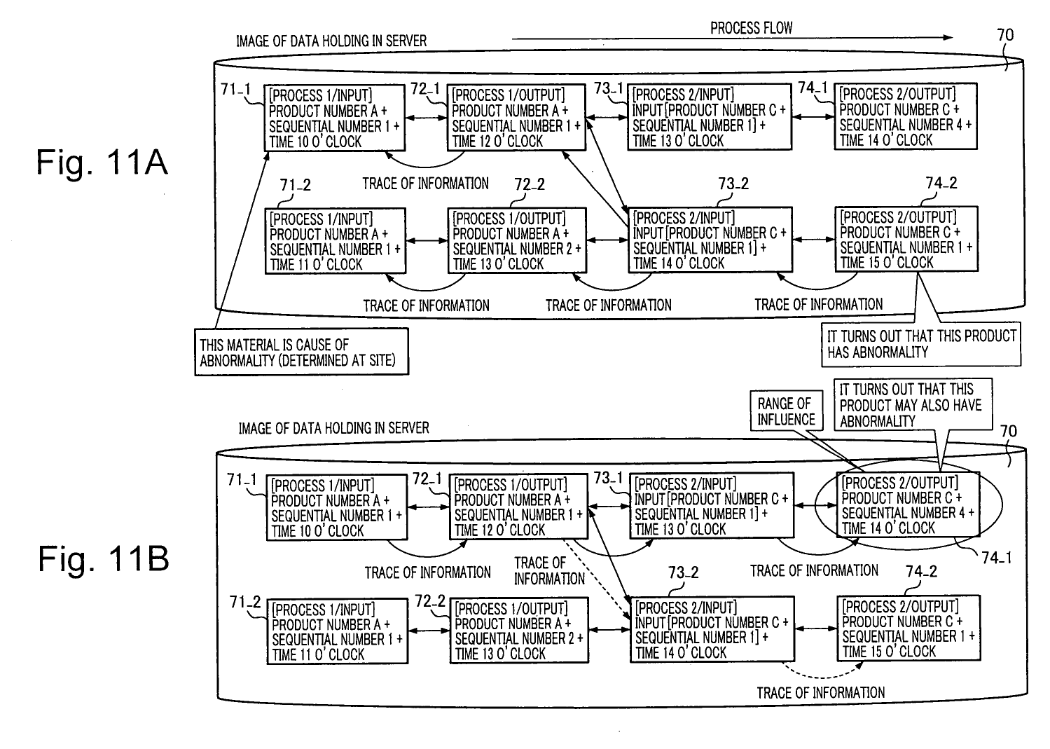

FIG. 11 is a diagram showing a defect cause identification method and an influence range identification method using traceability management data in an embodiment of the present invention.

If it turns out that there is any abnormality in a product corresponding to output result data 64_2, which is product number C+sequential number 1+time 15 o'clock”, as shown in FIG. 11(a), it is eventually determined, with the use of the image of data holding 70 described above, that the material corresponding to the process 1 input data 71_1, “product number A/sequential number 1/time 10 o'clock”, is the cause of the abnormality, from the link between output result data 74_2 and process 2 input data 73_2, the link between process 2 input data 73_2 and the process 1 output data 72_1, and the process 1 output data 72_1 and the process 1 input data 71_1. Thus, it is possible to identify the cause of the abnormality by tracing the link from the next processes to preceding processes.

When the material of “product number A/sequential number 1/time 10 o'clock” is identified to be the cause of the abnormality as described above, the range which may be influenced by the abnormality of the material can be determined in a manner described below. That is, by tracing the link between the process 1 input data 71_1 indicating the material of “product number A/sequential number 1/time 10 o'clock” and the process 1 output data 72_1, the link between the process 1 output data 72_1 and the process 2 input data 73_1, and the link between the process 2 input data 73_1 and the process 2 output data 74_1 with the use of the image of data holding 70 described above, as shown in FIG. 11(b), it is known that not only the above-stated product of “product number C/sequential number 4/time 15 o'clock” (the process 2 output data 74_2) but also the product of “product number C/sequential number 4/time 14 o'clock” may be influenced by the abnormality.

Next, the traceability management data in this embodiment will be described.

An example of data required for performing product traceability management in this embodiment is shown below.

(1) Material Kanban Data—A Product Kanban of a Preceding Process

A Kanban (information) attached to a material to be used for a specified process

“Product number/sequential number/manufacture start time and date”, manufacture completion time and date, use start time and date, use end time and date . . .

The part of “product number/sequential number/manufacture start time and date” is a part corresponding to a serial key. However, in the case where serial management with the use of material history (lot No.) is possible, supplier, product number and lot No. can be substituted.

(2) Product Kanban Data

A kanban (information) attached to a product manufactured in a specified process

“Product number/sequential number/manufacture start time and date”, manufacture completion time and date, use start time and date, use end time and date . . .

The part of “product number/sequential number/manufacture start time and date” is a part corresponding to a serial key.

(3) Stamp-On-Product Data

Data (information) attached for identification of a finished product

“Product number+sequential number+manufacture start time and date of product kanban”+stamped number

The part of “product number+sequential number+manufacture start time and date of product kanban” is a part to identify data.

(4) Quality Information Data

Result data (information) indicating the quality of a product inspected in a specified process

“Product number+sequential number+manufacture start time and date of product kanban”+inspection result data (such as dimensions and strength)

The part of “product number+sequential number+manufacture start time and date of product kanban” is a part to identify data.

(5) Manufacture Conditions Data

Manufacture conditions data (information) set for equipment in a specified process

“product number+sequential number+manufacture start time and date of product kanban”+a group of manufacture conditions data (such as pressure and temperature)

The part of “product number+sequential number+manufacture start time and date of product kanban” is a part to identify data.

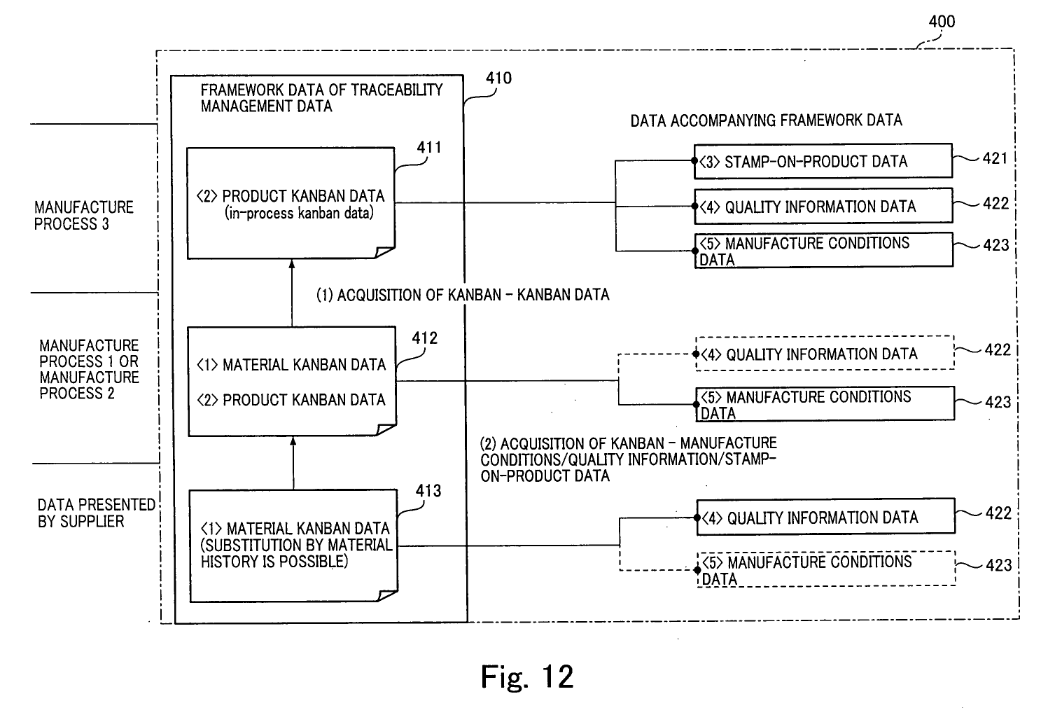

FIG. 12 is a diagram showing mutual relation among the traceability management data.

As shown in FIG. 12, traceability management data 400 is made up of framework data 410 made up of product kanban data 411 (in-process kanban data), material kanban data and product kanban data 412 and material kanban data 413 (for which material history can be substituted); stamp-on-product data 421, quality information data 422 and manufacture conditions data 423 accompanying the product kanban data 411; quality information data 422 and manufacture conditions data 423 accompanying the material kanban data and product kanban data 412; and quality information data 422 and manufacture conditions data 423 accompanying the material kanban data 413.

The material kanban data 413 is data presented by a supplier; the material kanban data or product kanban data 412 is data to be acquired from a product kanban or a material kanban at the process 1 or the process 2; and the product kanban data 411 is data to be acquired from a product kanban at the production process 3.

A product of the manufacture process 1 or the manufacture process 2 is positioned as a material at the next manufacture process 3.

The accompanying data such as the stamp-on-product data 421 and the quality information data 422 are formed by manufacture conditions data, quality information data and stamp-on-product data acquired together with a product kanban and a material kanban.

In FIG. 12, an arrow indicates association between information and an article; a black circle indicates association between pieces of information; and a dashed line indicates a possibility that there may be no information.

From the product kanban data 411 and the material kanban data and product kanban data 412 of the traceability management data 400, “kanban-kanban data” is acquired, and from the material kanban data and product kanban data 412 and the material kanban data 413, “kanban-manufacture conditions/quality information/stamp-on-product data” is acquired. The “kanban-kanban data” and the “kanban-manufacture conditions/quality information/stamp-on-product data” will be described later.

Next, a method for collecting the traceability management data in this embodiment will be described.

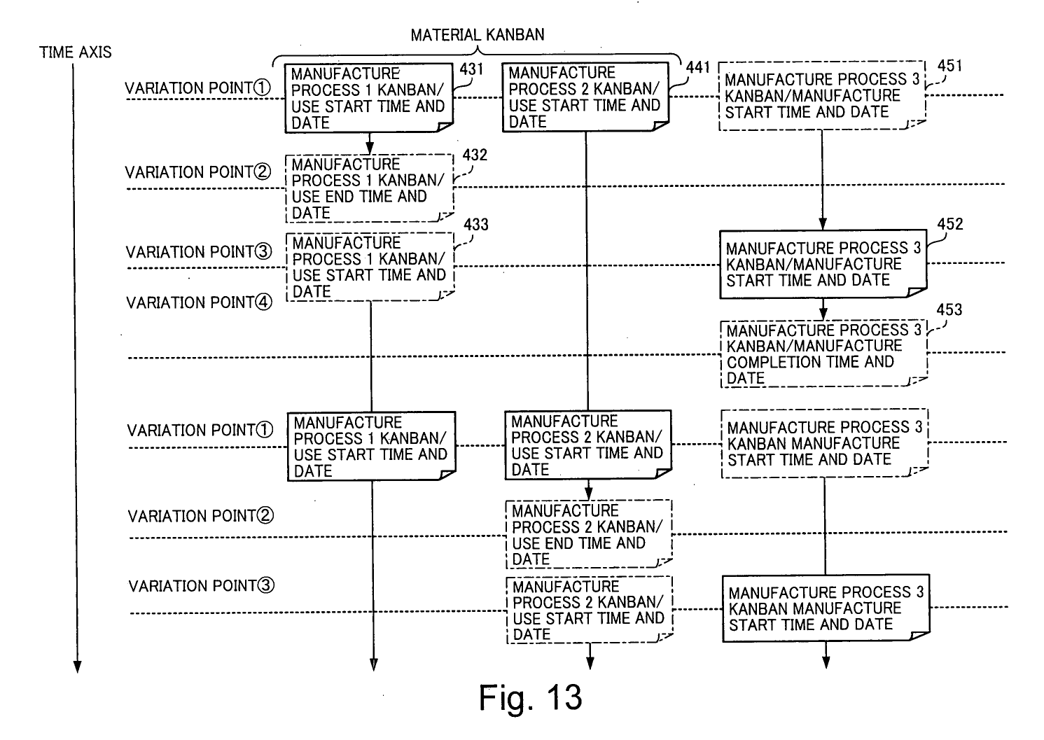

FIG. 13 is a diagram showing the flow of an operation of acquiring “kanban-kanban data” in this embodiment.

FIG. 13 shows the flow of an operation of collecting material kanban data and product kanban data and acquiring “kanban-kanban data” along the vertical-direction time axis.

Here, in this embodiment, the point in time of starting use of a material or manufacture of a product, and the point in time of ending use of the material or manufacture of the product are expressed as variation points.

In FIG. 13, information at each variation pint is indicated by being surrounded by dashed-dotted lines.

At a variation point 1, material kanban data of the manufacture process 1 and the time and date of starting use of the material 431 and material kanban data of the manufacture process 2 and the time and date of starting use of the material 441 are read, and at the same time, product kanban data of the manufacture process 3 and the time and date of starting use of the product 451 is read.

Next, at a variation point 2, when use of the material of the manufacture process 1 ends, material kanban data of the manufacture process 1 and the time and date of ending use of the material 432 are read.

Next, at a variation point 3, when use of the material of the manufacture process 1 starts, material kanban data of the manufacture process 1 and the time and date of starting use of the material 433 are read, and at the same time, product kanban data of the manufacture process 3 and the time and date of starting manufacture of the product 452 are read.

Next, at a variation point 4, when manufacture of the product of the manufacture process 3 ends, product kanban data of the manufacture process 3 and the time and date of completing manufacture of the product 453 are read.

Next, the above operation is repeated again for the variation point 1, the variation point 2, . . .

As described above, the same time and date is recorded in the multiple pieces of kanban information read at the same variation point, and therefore, it is possible to associate product information and material information with each other based on the time and date.

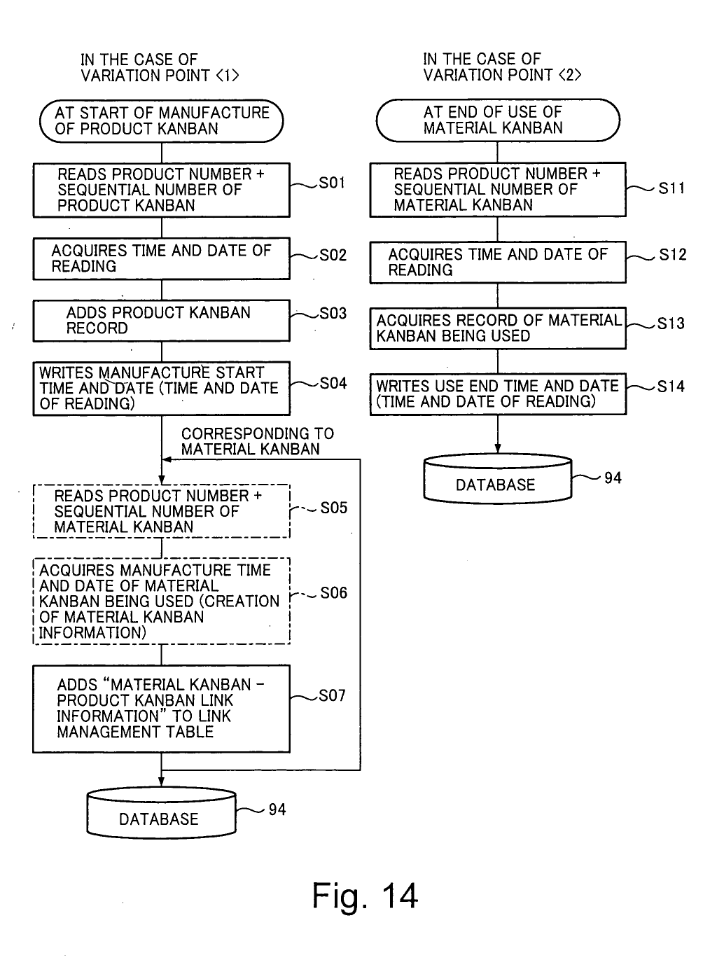

FIG. 14 is a part of a flowchart showing the flow of processing for acquiring “kanban-manufacture conditions/quality information/stamp-on-product data” in this embodiment.

In FIG. 14, indispensable processing steps are indicated by being surrounded by actual lines, and processing steps which are not indispensable are indicated by being surrounded by dashed-dotted lines.

As shown in FIG. 14, in the case of the variation point 1, the product number+sequential number of a product kanban is read first when manufacture of the product kanban starts (step S01); the time and date of the reading is acquired (step S02); a product kanban record is added (step S03); and the above time and date of the reading is written as the manufacture start time and date of the product kanban record (step S04).

Next, acquisition of material kanban data is started. That is, the product number+sequential number of a material kanban is read (step S05), and the manufacture start time and date of the material kanban being used is acquired to create material kanban information (step S06). Then, “material kanban-link information about product kanban” is added to a link management table (see FIG. 19; details will be described later) (step S07). The acquisition of material kanban data at steps S05 to S07 is repeatedly performed for all the materials used in the process. When the processing for all the materials ends, the collected information is recorded in the traceability management database 94 (see FIG. 1).

In the case of the variation point 2, the product number+sequential number of the product kanban is read first when use of the product kanban ends (step S11); the time and date of the reading is acquired (step S12); the record of the material kanban being used is acquired (step S13); the above time and date of the reading is written as the time and date of ending use of the material (step S14); and the information is recorded in the traceability management database 94 (see FIG. 1).

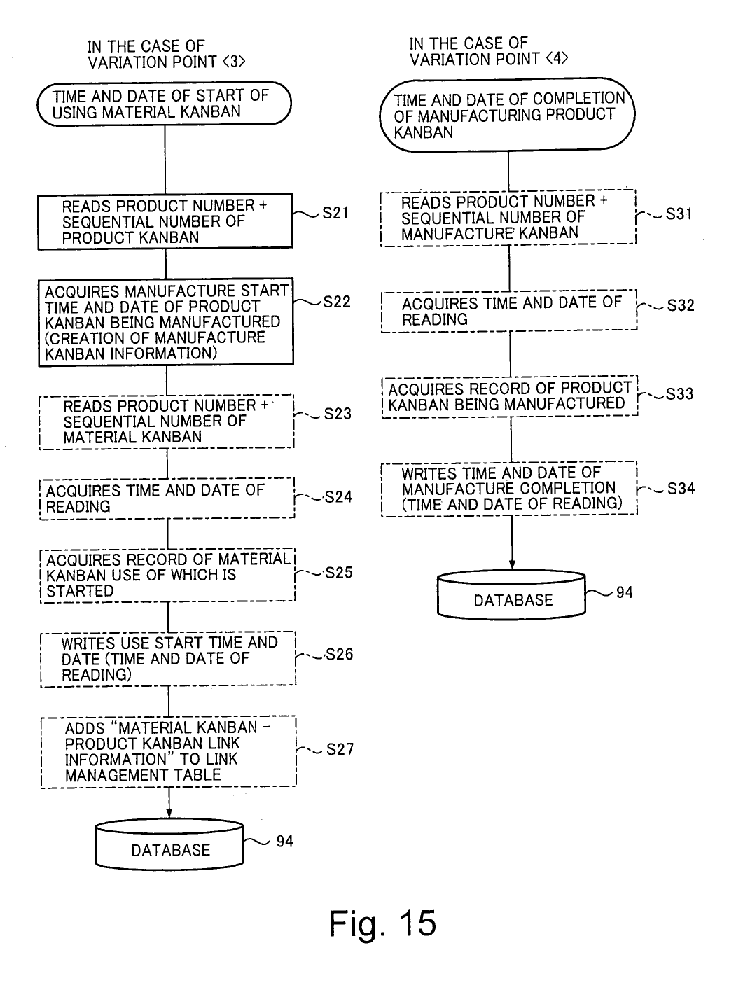

FIG. 15 is a part of a flowchart showing the flow of processing for acquiring “kanban-kanban data” in this embodiment.

In FIG. 15, indispensable processing steps are indicated by being surrounded by actual lines, and processing steps which are not indispensable are indicated by being surrounded by dashed-dotted lines.

As shown in FIG. 15, in the case of the variation point 3, the product number+sequential number of a product kanban is read first when manufacture of a material kanban starts (step S21); the manufacture start time and date of the product kanban being manufactured is acquired to create product kanban information (step S22); the product number+sequential number of the material kanban is read (step S23); and the time and date of the reading is acquired (step S24); the record of the material kanban the use of which is started is acquired (step S25); the above time and date of the reading is written as the time and date of starting use (step S26); “material kanban-link information about product kanban” is added to the link management table (see FIG. 19; details are will described later) (step S27); and the collected information is recorded in the traceability management database 94 (see FIG. 1).

In the case of the variation point 4, the product number+sequential number of the product kanban is read first when manufacture of the product kanban ends (step S31); the time and date of the reading is acquired (step S32); the record of the product kanban being manufactured is acquired (step S33); the time and date of the reading is written as the time and date of completing manufacture (step S34), and the information is recorded in the traceability management database 94 (see FIG. 1).

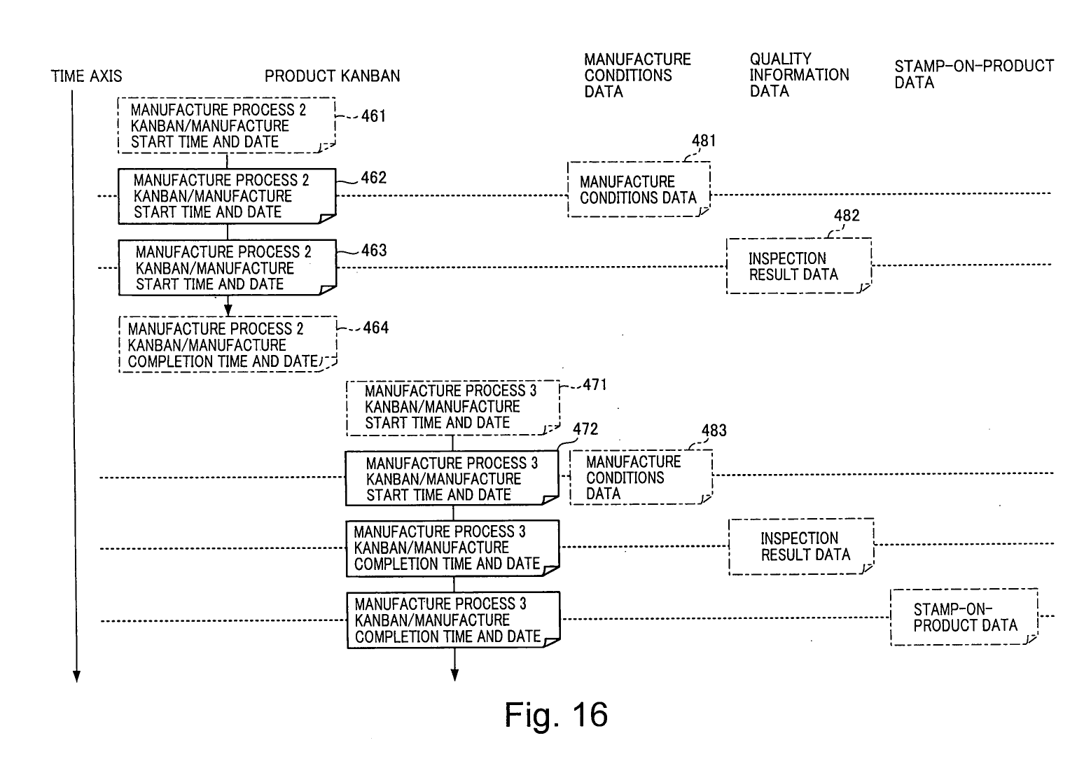

FIG. 16 is a diagram showing the flow of an operation of acquiring “kanban-manufacture conditions/quality information/stamp-on-product data” in this embodiment.

In FIG. 16, indispensable information is indicated by being surrounded by actual lines, and information which is not indispensable is indicated by being surrounded by dashed-dotted lines.

FIG. 16 shows an operation of acquiring product kanban data and accompanying data along the vertical-direction time axis.

First, at the point in time of starting manufacture of a product at the manufacture process 2, manufacture process 2 kanban data and the time and date of starting manufacture of the product 461 is read.

Next, when manufacture conditions data about the product is obtained, manufacture conditions data 481 is read, and the manufacture process 2 kanban data at that point in time and the time and date of starting manufacture of the product 462 are also read.

Next, when inspection result data of the product is obtained, the inspection result data 482 is read, and manufacture process 2 kanban data at that point in time and the time and date of starting manufacture of the product 463 are also read.

Next, when manufacture of the product at the manufacture process 2 is completed, the manufacture process 2 kanban data and the time and date of completing manufacture of the product 464 are read.

Next, when manufacture of the product at the manufacture process 3 starts, manufacture process 3 kanban data and the time and date of starting manufacture of the product 471 are read.

Next, when manufacture conditions data of the product is obtained, the manufacture conditions data 483 is read, and the manufacture process 3 kanban data at that point in time and the time and date of starting manufacture of the product 472 are read.

In this way, when accompanying data such as the manufacture conditions data, the inspection result data and the stamp-on-product data is read, the time and date of the reading is recorded not only in the accompanying data but also in the product kanban data at that time.

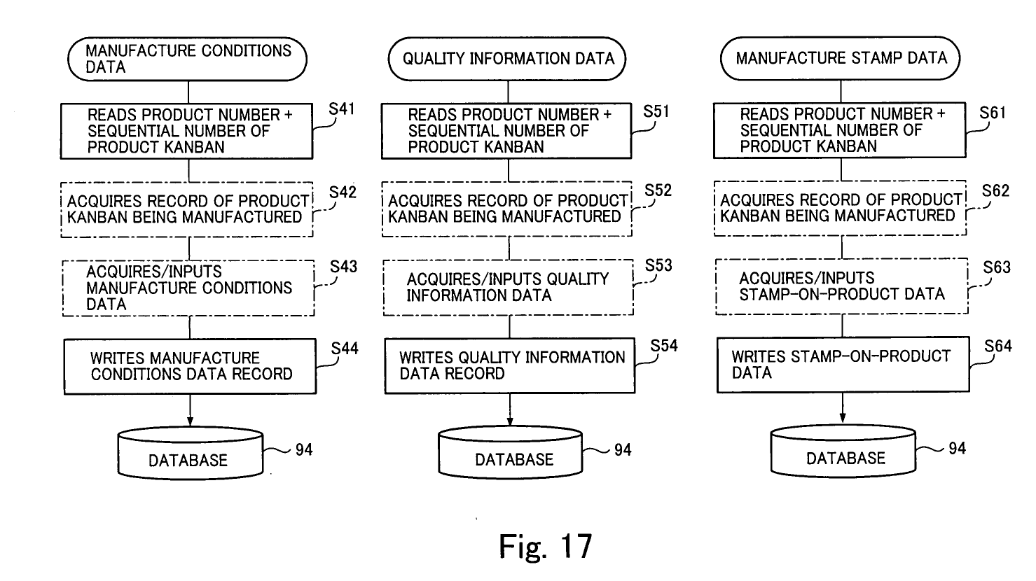

FIG. 17 is a flowchart showing the flow of an operation of acquiring “kanban-manufacture conditions/quality information/stamp-on-product data” in this embodiment.

In FIG. 17, indispensable processing steps are indicated by being surrounded by actual lines, and processing steps which are not indispensable are indicated by being surrounded by dashed-dotted lines.

As for manufacture conditions data, when the manufacture conditions data about the product is obtained, the product number+sequential number of the product kanban is read first (step S41); the record of the product kanban being manufactured is acquired (step S42); the manufacture conditions data is acquired or inputted (step S43); and a record of the manufacture conditions data is written (step S44) and recorded in the traceability management database 94 (see FIG. 1).

As for quality information data, when the quality information data about the product is obtained, the product number+sequential number of the product kanban is read first (step S51); the record of the product kanban being manufactured is acquired (step S52); the quality information data is acquired or inputted (step S53); the record of the quality information data is written (step S54) and recorded in the traceability management database 94 (see FIG. 1).

As for stamp-on-product data, when the stamp-on-product data of the product is obtained, the product number+sequential number of the product kanban is read first (step S51); the record of the product kanban being manufactured is acquired (step S52); the stamp-on-product data is acquired or inputted (step S53); the record of the stamp-on-product data is written (step S54) and recorded in the traceability management database 94 (see FIG. 1).

Next, a traceability management database in this embodiment will be described.

The traceability management database 94 (see FIG. 1) in this embodiment is constituted by a kanban data management table, a kanban link management table, a stamp-on-product data management table, a quality information data management table and a manufacture conditions data management table, and it is formed in the information processor 95 (see FIG. 1).

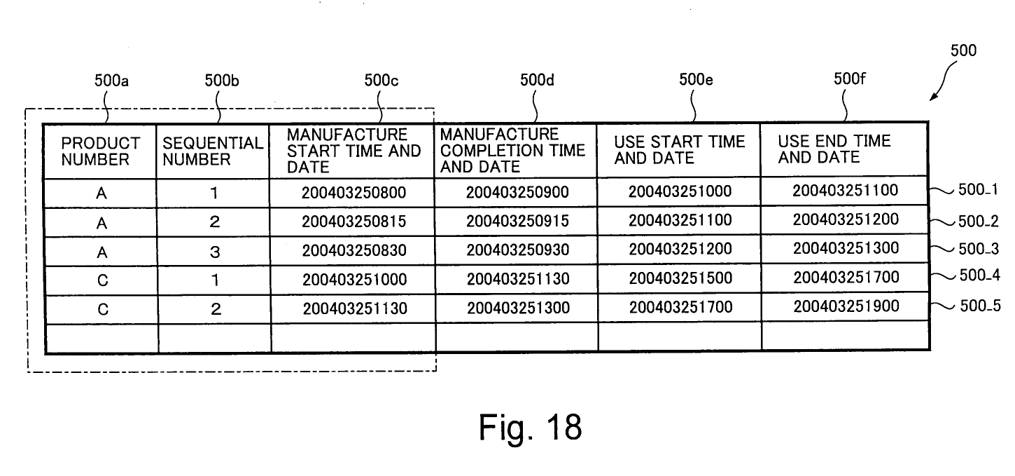

FIG. 18 is a diagram showing the file structure of the kanban data management table in this embodiment.

FIG. 18 shows the file structure of a kanban data management table 500. In this kanban data management table 500, there are stored kanban data 500_1, 500_2, 500_3, . . . each of which is configured by six items of a product number 500a, a sequential number 500b, manufacture start time and date 500c, manufacture completion time and date 500d, use start time and date 500e and use end time and date 500f. Among the data of these six items, the data of three items of the product number 500a, the sequential number 500b and the manufacture start time and date 500c which are surrounded by dashed-dotted lines is so-called “framework data,” and the data is stored in a format of serial data. Each of these kanban data 500_1, 500_2, 500_3, . . . corresponds to the product record stated in the present invention, and it is associated with one product or one group of the same kind of products.

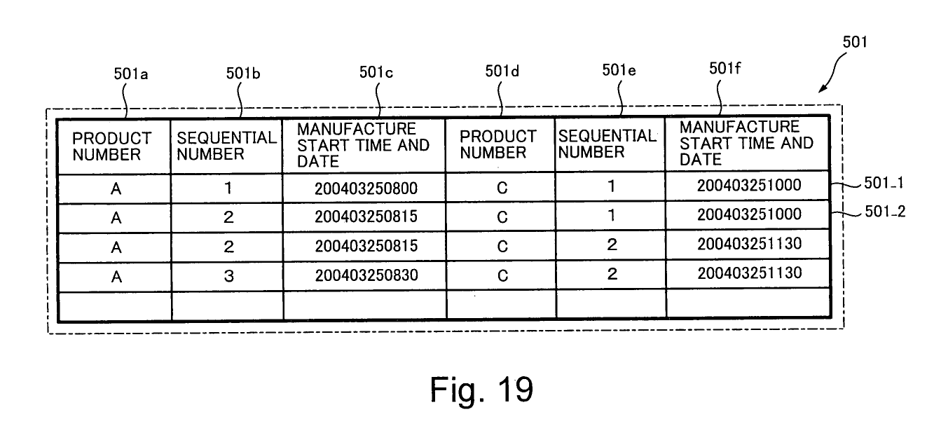

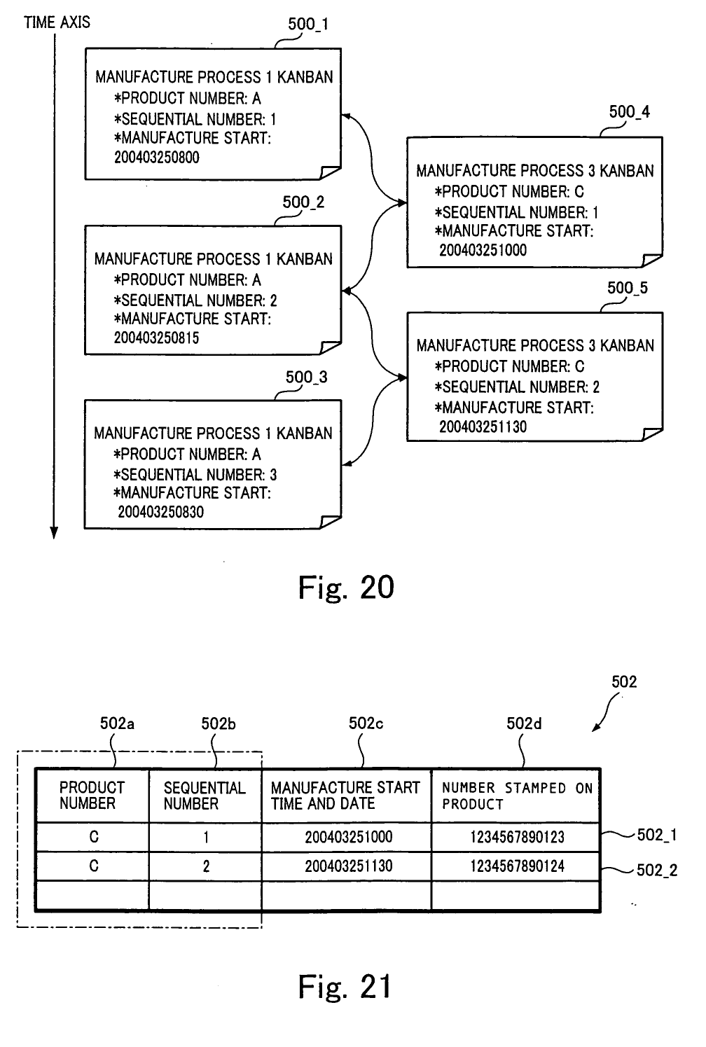

FIG. 19 is a diagram showing the file structure of the kanban link management table in this embodiment, and FIG. 20 is a diagram showing association relation between product records of unfinished products and product records of next-stage products based on link records in this embodiment.

FIG. 19 shows the file structure of a kanban link management table 501. In this kanban link management table 501, there are stored link records 501_1, 501_2, 501_3, . . . each of which is configured by six items of a product number 501a, a sequential number 501b, manufacture start time and date 501c, a product number 501d, a sequential number 501e and manufacture start time and date 501f. These link records are stored in a database in a form of serial data. In response to start of using an unfinished product associated with one product record for a next-stage product manufactured with the use of the unfinished product as a material or a part, such a link record associates the product record of the unfinished product and the product record of the next-stage product with each other.

This association is performed by retrieving a serial key configured by the framework data shown in FIG. 18, that is, the product number 500a, the sequential number 500b and the manufacture start time and date 500c. For example, a link record 501_1 associates the product record 500_1 of the unfinished product and the product record 500_4 of the next-stage product shown in FIG. 18 with each other. This is based on the fact that the use start time and date 500e of the product record 500_1, “200403251000” is included within the range from the manufacture start time and date 500c of the product record 500_4, “200403251000” to the manufacture completion time and date 500d, “200403251130”.

The link record 501_2 shown in FIG. 19 associates the product record 500_2 of the unfinished product and the product record 500_4 of the next-stage product shown in FIG. 18 with each other. This is based on the fact that the use start time and date 500e of the product record 500_2, “200403251100” is included within the range from the manufacture start time and date 500c of the product record 500_4, “200403251000” to the manufacture completion time and date 500d, “200403251130”.

The association relation between the product record of the unfinished product, that is, material-side kanban data and the product record of the next-stage product, that is, product-side kanban data is as shown in FIG. 20.

That is, the product records 500_1, 500_2 and 500_3 of an unfinished product are shown on the left side of FIG. 20, and the products records 500_4 and 500_5 of the next-stage product are shown on the right side, along the vertical direction time axis. For example, the product records 500_1 and 500_2 on the left side (the material side) are associated with the product record 500_4 on the right side (the product side), and this association relation is indicated as the link record 501_1 shown in FIG. 19. Similarly, the product records 500_2 and 500_3 on the left side (the material side) are associated with the product record 500_5 on the right side (the product side), and this association relation is indicated as the link record 501_2 shown in FIG. 19.

FIG. 21 is a diagram showing the file structure of the stamp-on-product data management table in this embodiment.

FIG. 21 shows the file structure of a stamp-on-product data management table 502. In this stamp-on-product data management table 502, there are stored stamp-on-product records 502_1, 502_2, . . . each of which is configured by four items of a product number 502a, a sequential number 502b, manufacture start time and date 502c and a number stamped on product 502d. Among the four items, three items of the product number 502a, the sequential number 502b and the manufacture start time and date 502c which are surrounded by dashed-dotted lines are so-called “framework data” and are stored in a format of serial data. The number stamped on product 502d corresponds to the information accompanying a product stated in the present invention. The number stamped on product 502d is one of pieces of information for identifying a product at shipment, and description of the content of the stamp, the process for attaching a stamp and the like is omitted here.

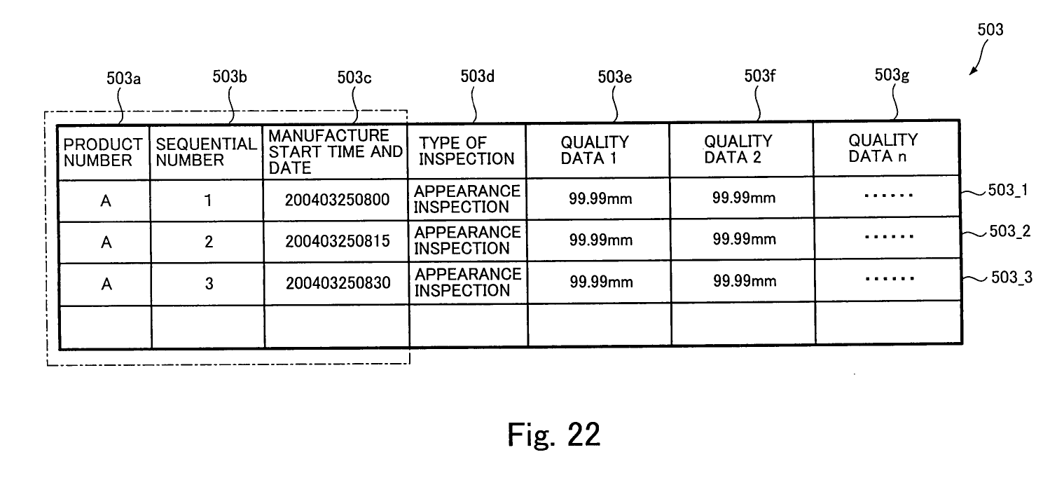

FIG. 22 is a diagram showing the file structure of the quality information data management table in this embodiment.

FIG. 22 shows the file structure of a quality information data management table 503. In this quality information data management table 503, there are stored quality information records 503_1, 503_2, 503_3, . . . each of which is configured by six items of a product number 503a, a sequential number 503b, manufacture start time and date 503c, inspection type 503d, quality data (1) 503e, quality data (2) 503f and quality data (n) 503g. Among the six items, three items of the product number 503a, the sequential number 503b and the manufacture start time and date 503c which are surrounded by dashed-dotted lines are so-called “framework data” and are stored in a format of serial data. The inspection type 503d, the quality data (1) 503e, the quality data (2) 503f and the quality data (n) 503g correspond to the information accompanying a product stated in the present invention.

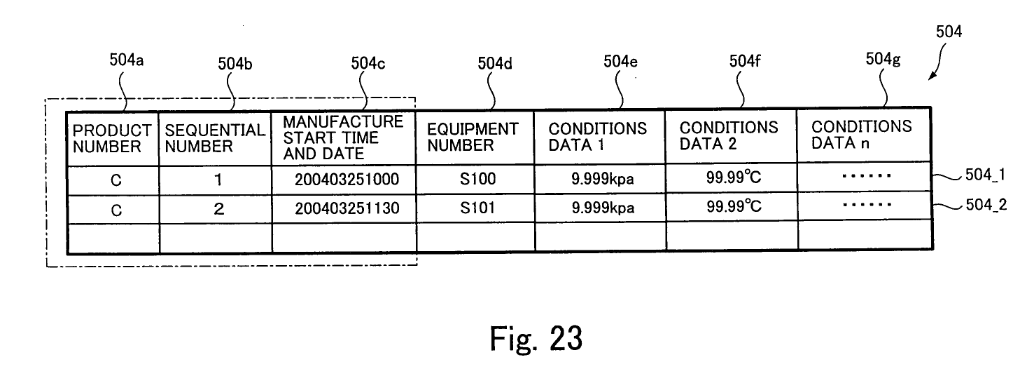

FIG. 23 is a diagram showing the file structure of the manufacture conditions data management table in this embodiment.

FIG. 23 shows the file structure of a manufacture conditions data management table 504. In this manufacture conditions data management table 504, there are stored manufacture conditions records 504_1, 504_2, 504_3, . . . each of which is configured by six items of a product number 504a, a sequential number 504b, manufacture start time and date 504c, equipment number 504d, conditions data (1) 504e, conditions data (2) 504f and conditions data (n) 504g. Among the six items, three items of the product number 504a, the sequential number 504b and the manufacture start time and date 504c which are surrounded by dashed-dotted lines are so-called “framework data” and are stored in a format of serial data. The equipment number 504d, the conditions data (1) 504e, the conditions data (2) 504f, the conditions data (n) 504g correspond to the information accompanying a product stated in the present invention.

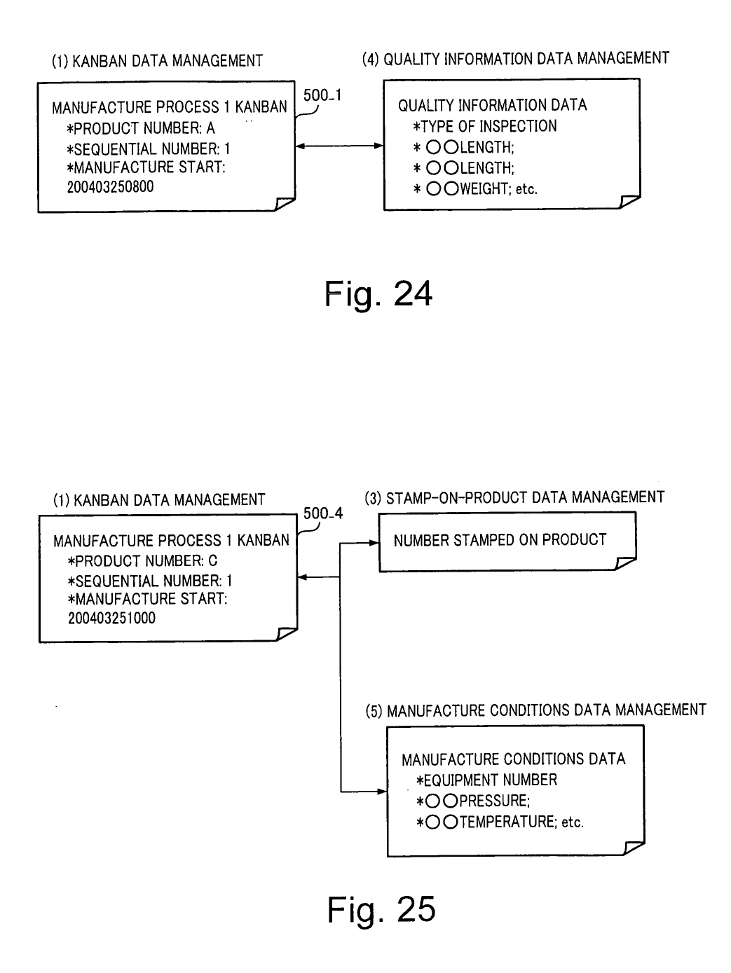

FIG. 24 is a diagram showing association relation between a product record and quality information data accompanying a product in this embodiment.

That is, FIG. 24 shows the product record 500_1 (see FIG. 18) on the left side, and quality information data corresponding thereto, that is, the inspection type 503d, the quality data (1) 503e, the quality data (2) 503f and the quality data (n) 503g of the quality information record 503_1 shown in FIG. 22 on the right side. This association relation is shown as the quality information record 503_1 shown in FIG. 22.

FIG. 25 is a diagram showing association relation between a product record, and stamp-on-product data and manufacture conditions data accompanying a product in this embodiment.

FIG. 25 shows the product record 500_4 (see FIG. 18) on the left side, and stamp-on-product data and manufacture conditions data corresponding thereto, that is, the number stamped on product 502d (see FIG. 21), the equipment number 504d (see FIG. 23), the conditions data (1) 504e, the conditions data (2) 504f and the conditions data (n) 504g on the right side. The association relation is shown in the stamp-on-product data management table 502 shown in FIG. 21 and the manufacture conditions data management table 504 shown in FIG. 23.

Next, description will be made on trace processing for identifying the cause of an abnormality with the use of traceability management data in this embodiment.

In order to perform the trace processing for identifying the cause of an abnormality with the use of traceability management data, a trace processing section having a trace processing function, for example, can be provided in the traceability management data creation apparatus 90 (see FIG. 1) of this embodiment.

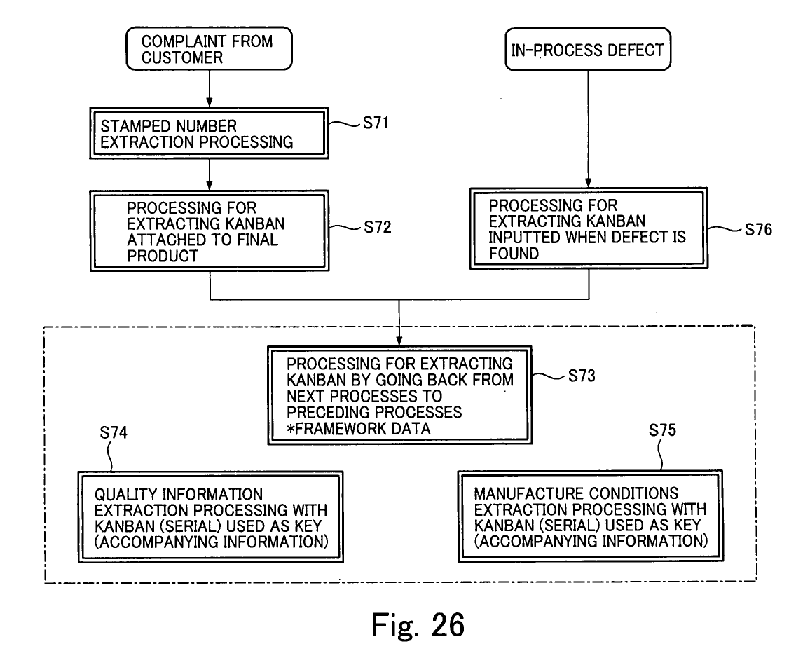

FIG. 26 is a diagram showing a procedure for identifying the cause of an abnormality with the use of the traceability management data of this embodiment.

Here, the case of a product delivered to a customer is assumed. Since a kanban attached during manufacture has already been removed, the trace operation is performed by going back from the kanban of a final product based on the number stamped on the product.

As shown in FIG. 26, in a case of a complaint from a customer, processing for extracting a number stamped on product is performed based on the complaint (step S71).

Next, processing for extracting a kanban attached to the final product is performed (step S72).

Next, by going back from next processes to preceding processes, processing for extracting framework data (serial key) is performed (step S73).

Next, processing for extracting quality information (accompanying information) with the framework data (serial key) used as a key and processing for extracting manufacture conditions (accompanying information) with the framework data (serial key) used as a key are performed (steps S74 and S75). In these accompanying information extraction processings, extraction of quality information and manufacture conditions is repeatedly performed with kanban data of a target process used as a key.

The identification of the cause of an abnormality from quality information or manufacture conditions may be automatically performed by a so-called “scope search” method or may be performed based on a person's determination.

If any in-process defect occurs as shown on the upper right part of FIG. 26, the cause of an abnormality can be identified from the in-process defect. That is, by performing processing for extracting an kanban inputted when the in-process defect is found (step S76), and then performing processing for extracting framework data (serial key) of the kanban by going back from next processes to preceding processes (step S73), processing similar to the extraction processing based on a customer's complaint can be performed subsequently.

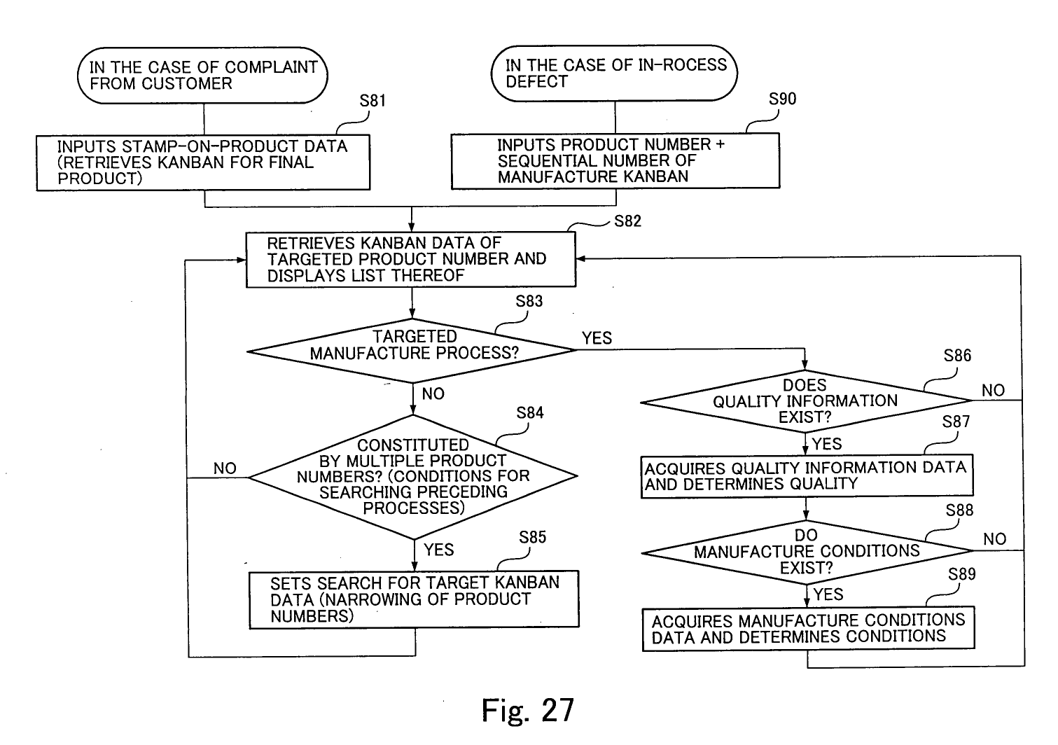

FIG. 27 is a flowchart of trace processing performed when the cause of an abnormality is identified with the use of the traceability management data of this embodiment.

This flowchart is on the assumption of the case of a product delivered to a customer, similarly to the case of FIG. 26. Since a kanban attached during manufacture has already been removed, a trace operation is performed by going back from the kanban of a final product, based on the number stamped on the product.

In the case of a complaint from a customer, a number-stamped-on-product data is inputted, or a kanban of the final product is retrieved based on the complaint (step S81).

Next, kanban data corresponding to a target product number is retrieved, and a list of the retrieved data is displayed (step S82).

Next, it is determined whether or not the retrieved data is data of a target manufacture process (step S83). If it is not the data of the target process, then the processing proceeds to step S86. If it is the data of the target process, then the processing proceeds to step S84.

At step S84, it is determined whether or not the data is data involving multiple product numbers. If it is data involving multiple product numbers, then the processing proceeds to step S85. If it is not data involving multiple product numbers, then the processing returns to step S82.

At step S85, conditions to retrieve target kanban data are set to narrow the product numbers, and the processing returns to step S82.

At step S86, it is determined whether or not there is quality information. If there is not quality information, then the processing returns to step S82. If there is quality information, the processing proceeds to step S87.

At step S87, the quality information is acquired, and quality is determined. Then, the processing proceeds to step S88.

At step S88, it is determined whether or not there is manufacture conditions information. If there is not manufacture conditions information, the processing returns to step S82. If there is manufacture conditions information, the processing proceeds to step S89.

At step S89, the manufacture conditions information is acquired, and manufacture conditions are determined. Then, the processing returns to step S82.

If any in-process defect occurs, data of the product number+sequential number of a product kanban is inputted (step S90), and then, the processings at and after step S82 are performed. The processings at and after step S82 are similar to those of the case of a complaint from a customer.

Next, description will be made on an operation of processing for identifying the range influenced by a defective article with the traceability management data of this embodiment.

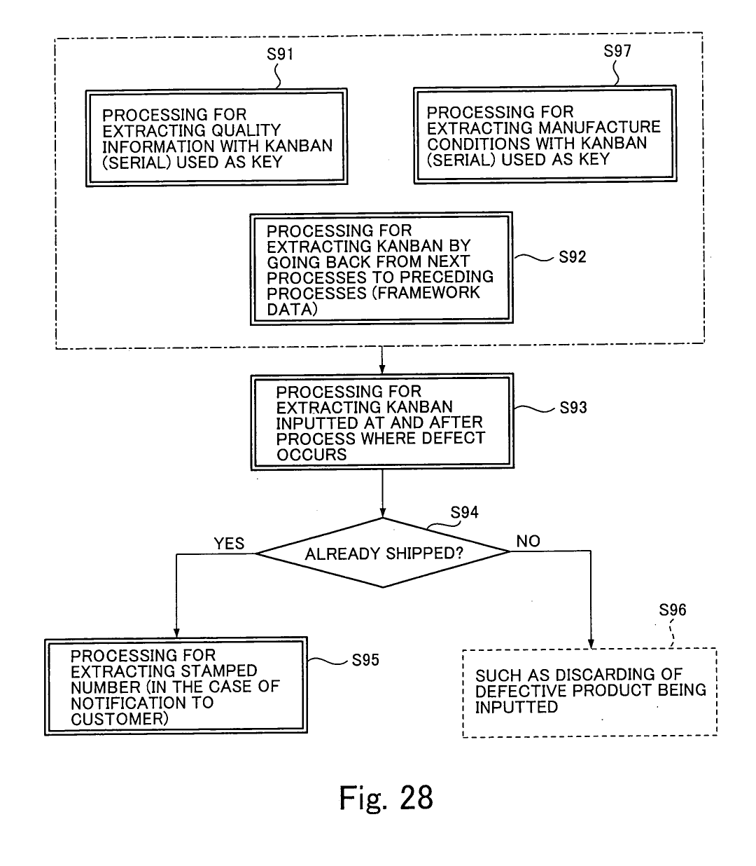

FIG. 28 is a diagram showing a procedure for identifying the range of influence of a defective article with the use of the traceability management data of this embodiment.

As shown in FIG. 28, if the processing is performed based on quality information, processing for extracting the quality information with a kanban (serial) used as a key is performed first (step 91).

Next, processing for extracting framework data of the kanban is performed through going back from next processes to preceding processes (step S92). Here, kanban data indicating a same state similar to an identified cause is extracted.

Next, processing for extracting kanbans inputted in the processes at and after the process where the defect occurs is performed (step S93).

Next, it is determined whether or not the extracted product has already been shipped (step S94). If it has already been shipped, then processing for extracting a number stamped on product is performed (step S95). At step S95, if the product is a product to be delivered to a customer, the number stamped on the product at shipment is notified to the customer since the kanban used during manufacture has already been removed.

If the product has not been shipped as a result of the determination at step S94, then measures are taken such as discarding the inputted defective product (step S96).

If the processing is performed based on manufacture conditions information, processing for extracting is performed first (step S97), and then, the processings at and after S92 are performed. The processings at and after S92 are similar to those of the case of quality information.

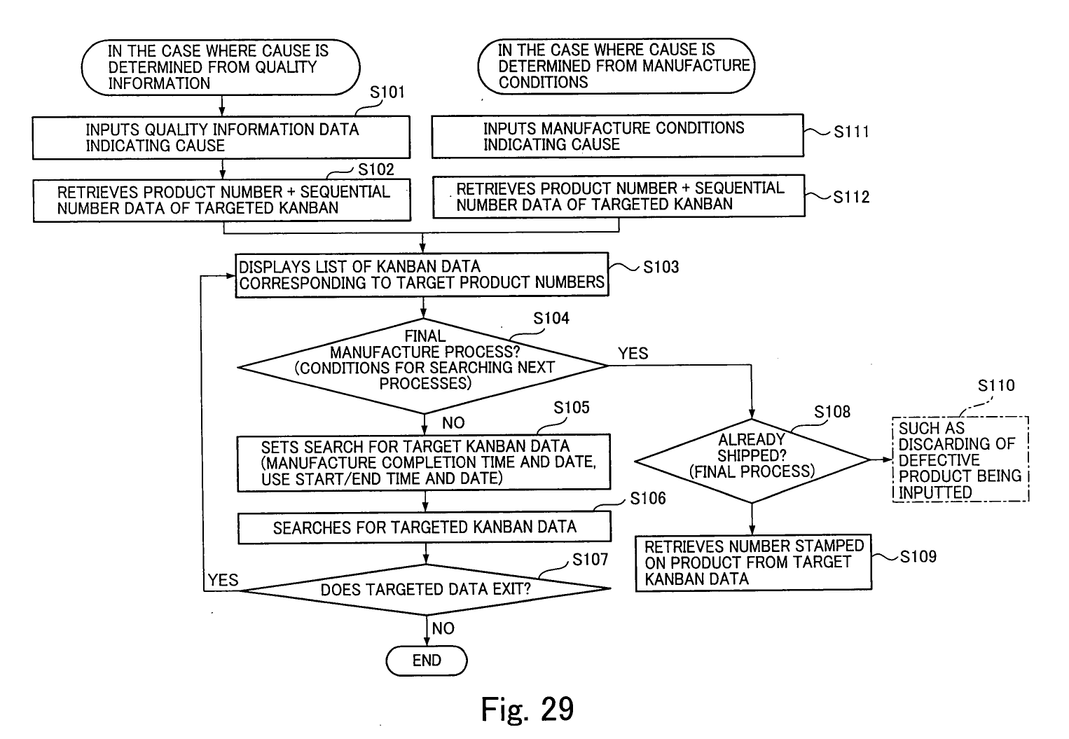

FIG. 29 is a flowchart of trace processing performed when the range of influence of a defect is identified with the use of the traceability management data of this embodiment.

As shown in FIG. 29, if the cause is determined from quality information, the quality information data indicating the cause is inputted first (step S101).

Next, the product number+sequential number data of kanbans to be targeted is retrieved (step S102).

Next, a list of the target kanban data is displayed (step S103).

Next, it is determined, for each of the retrieved data, whether or not the data is for the final manufacture process (step S104). If it is not for the final manufacture process, then the processing proceeds to step S105. If it is for the final manufacture process, then the processing proceeds to step S108.

At step S105, conditions for retrieval of the target kanban data, that is, the manufacture completion time and date, the use start time and date, the use end time and date and the like are set.

Next, the target kanban data is retrieved (step S106). Next, it is determined whether or not there is more target kanban data (step S107). If there is more target kanban data, then the processing returns to step S103. If there is not any target kanban data, then the processing ends.

Meanwhile, at step S108, it is determined whether or not the product corresponding to the target kanban data has already been shipped, that is, whether or not the final process for the product has ended. If the product has already been shipped, then the processing proceeds to step S109. If the product has not been shipped, then measures are taken such as discarding the defective product which is still inputted (step S110).

If the cause of the defect is determined from manufacture conditions, data of the manufacture conditions indicating the cause is inputted first (step S111).

Next, the product number+sequential number data of kanbans to be targeted are retrieved (step S112), and then the processing proceeds to step S103. The processings at and after step S103 are similar to those of the case of quality information.

Next, description will be made on an example of trace for identifying the cause of a defect and trace for identifying the range of influence.

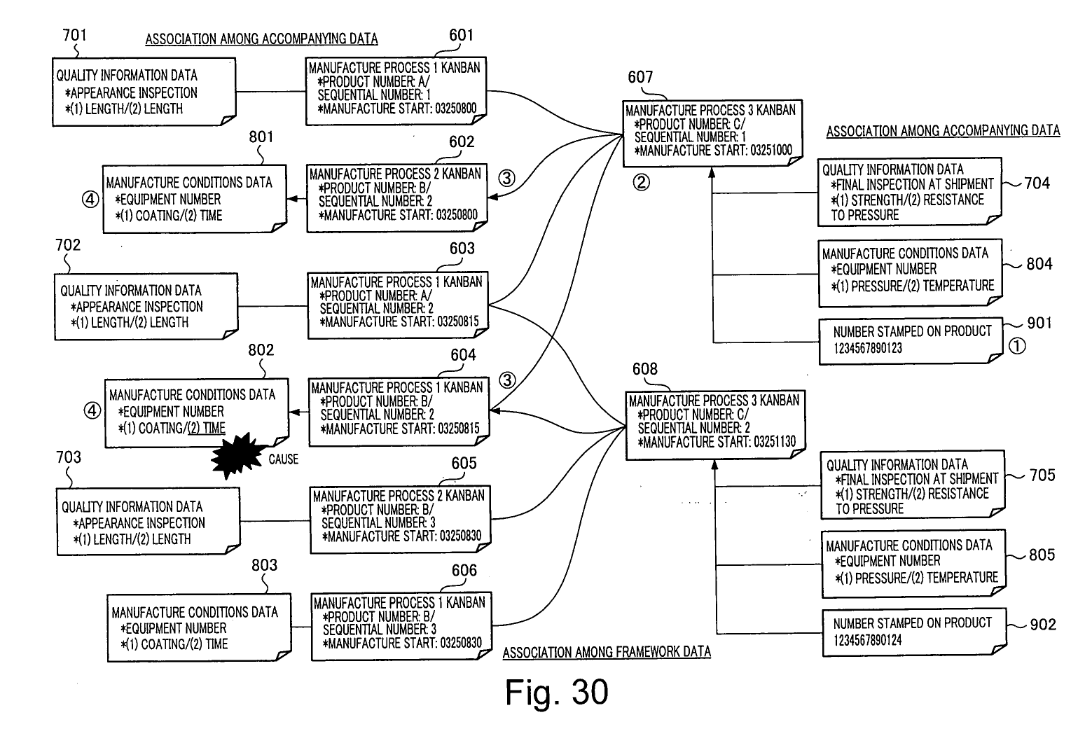

FIG. 30 is a diagram showing an example of a trace operation for identifying the cause of an abnormality with the use of the traceability management data of this embodiment.

FIG. 30 shows a process of a trace operation for identifying the cause of a defect performed with the use of traceability management data, for a manufacture process for manufacturing a PC cable of product number C from a connect of product number A and a wire portion of product number B. The trace operation is performed as follows:

(1) A report of electric leakage from the wire portion of a PC cable with a number stamped on product of “1234567890123” is made by a customer, and information 901 is obtained based on the report.

(2) The association relation between the information 901 and framework data is searched for. That is, the final manufacture kanban used when the product with the above number stamped on product was manufactured is searched for, and information 607, which is “manufacture process 3 kanban; product number: C; Sequential number: 1; manufacture start: 03251000”, is hit.

(3) Then, framework data associated with this information 607 is retrieved. It turns out that the product number C (PC cable) is constituted by the product number A (connector) and the product number B (wire portion), and it is assumed that the trouble is caused by a trouble in the product B (wire portion). Therefore, from among information 602, information 604 and information 606 related to manufacture of the wire portion, the information 604, which is “manufacture process 2 kanban; product number: B/; sequential number: 2; manufacture start: 03250815”, is extracted based on the manufacture start time and date.

(4) Next, the coating application time is regarded as a problem based on information 802, which is “manufacture conditions data; equipment number; (1) coating; (2) time”, accompanying the information 604. As a result of examination, it turns out to be the cause of the trouble that the coating application time was very short.

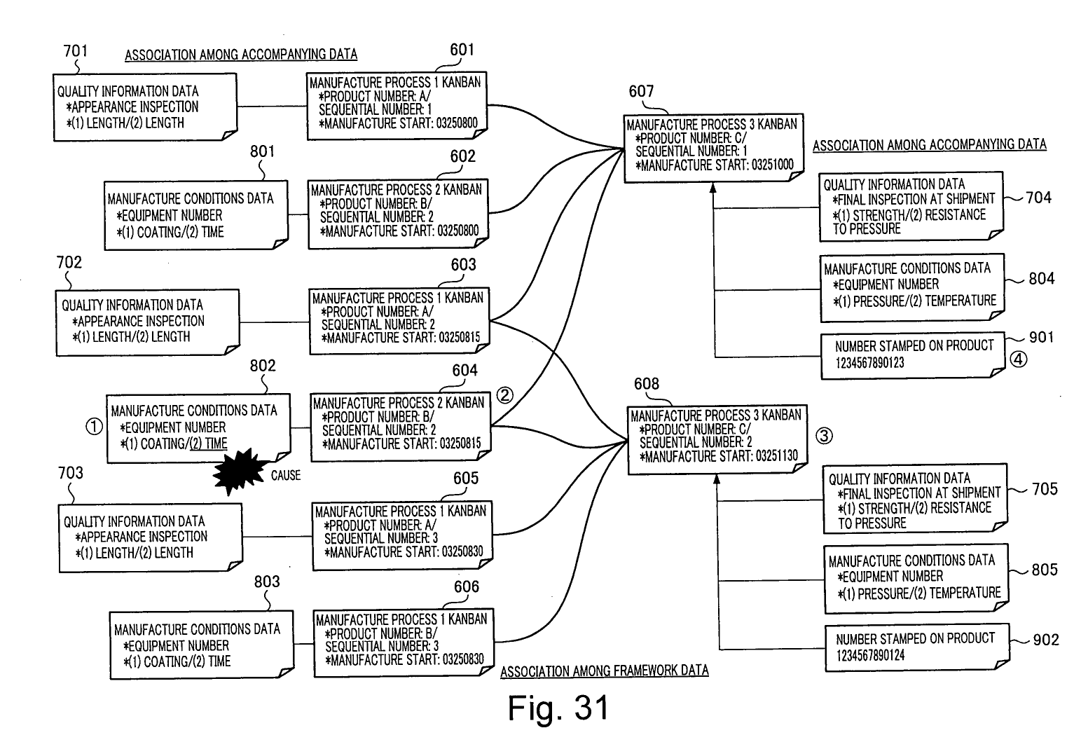

FIG. 31 is a diagram showing an example of a trace operation for identifying the range of influence with the use of the traceability management data of this embodiment.

FIG. 31 shows the traceability management data about the manufacture process for manufacturing a PC cable of product number C from a connector of product number A and a wire portion of product number B, similarly as shown in FIG. 30. The trace operation is performed as follows:

(1) It turns out to be the cause of the trouble that the coating application time was very short, from among manufacture conditions applied when the wire part was manufactured (information 802).

(2) By searching for a kanban used when the wire part was manufactured based on the information 802, the information 604, which is “manufacture process 2 kanban; product number: B; sequential number: 2; manufacture start: 03250815”, is extracted.

(3) The manufacture-side kanbans are searched in order to examine whether or not the manufactured parts were used for other products. As a result, it newly turns out that the part is also used in information 608, which is “manufacture process 3 kanban; product number: C/; sequential number: 2; manufacture start: 03251130”.

(4) It turns out, from accompanying information 902, that the product manufactured under the “manufacture process 3 kanban; product number: C/; sequential number: 2; manufacture start: 03251130” is a product with a number stamped on product of “1234567890124”, and the product has already been shipped.

Next, an embodiment of a traceability management data creation program of the present invention will be described.

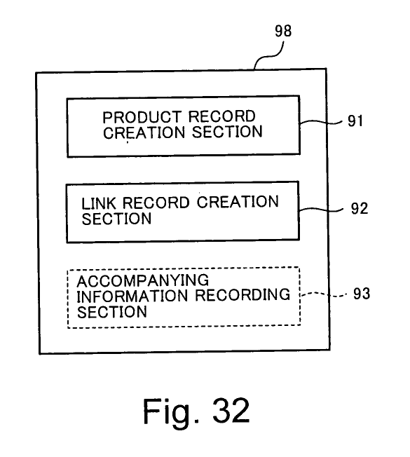

FIG. 32 is a diagram showing an embodiment of a traceability management data creation program of the present invention.

This traceability management data creation program 98 is a program which is executed in the information processor 95 (see FIG. 1) for executing programs and which causes the information processor 95 to operate as a traceability management data creation apparatus 90 (see FIG. 1) for creating data for management of traceability for identifying, from one product, products used for this one product as materials or parts and products using this one product as a material or a part, in a kanban production system in which, for each of unfinished products to be used for the next-stage products as materials or parts and finished products, manufacture is performed by causing a kanban used repeatedly and circularly to accompany each of the products, the traceability management data creation program 98 causing the information processor to operate as the traceability management data creation apparatus 90 including:

the product record creation section 91 which creates a product record associated with one product or one group of the same kind of products, the product record including a product number of a product, a sequential number of a kanban accompanying the product, and a point in time of starting manufacture of the product; and

the link record creation section 92 which creates a link record which associates a product record of an unfinished product and a product record of a next-stage product manufactured with the use of the unfinished product as a material or a part.

The traceability management data creation program 98 may be configured to cause the information processor 95 to operate as the traceability management data creation apparatus 90 further including the accompanying information recording section 93 which records information accompanying a product in association with the product record of the product.

The traceability management data creation program 98 is stored in a storage medium, for example, an MO, DVD, CD-ROM or a flexible disk. For example, by using an MO as the storage medium, inserting the MO 85 (see FIG. 1), in which the traceability management data creation program 98 is stored, into the MO mounting port 85a of the file server 80_1, and causing the main body section 80a to read the traceability management data creation program 98 to install it on the storage device in the file server 80_1, the traceability management data creation apparatus 90 can be formed in the file server 80_1 of the present invention.

1. A traceability management data creation method for creating data for management of traceability for identifying, from one product, products used for this one product as materials or parts and products using this one product as a material or a part, in a kanban production system in which, for each of unfinished products to be used for next-stage products as materials or parts and finished products, manufacture thereof is performed accompanied by a kanban used repeatedly and circularly for each of the products, wherein
a product record including a product number of a product, a sequential number of a kanban accompanying the product, and a point in time of starting manufacture of the product is created, the product record being associated with one product or one group of the same kind of products.

2. The traceability management data creation method according to claim 1, wherein, to a product record associated with an unfinished product, a point in time of starting use of the unfinished product for a next-stage product to be manufactured with the use of the unfinished product as a material or a product is further recorded.

3. The traceability management data creation method according to claim 1, wherein, in response to start of using an unfinished product associated with one product record, for a next-stage product to be manufactured with the use of the unfinished product as a material or a product, a link record is created to associate the product record of the unfinished product with the product record of the next-stage product.

4. The traceability management data creation method according to claim 1, wherein in response to end of manufacturing a product with which one product record is associated, a manufacture end point in time is recorded in the product record of the product.

5. The traceability management data creation method according to claim 1, wherein,
in response to start of manufacturing a next-stage product with which one product record is associated and which uses an unfinished product as a material or a part, a link record is created to associate the product record of the unfinished product with the product record of the next-stage product.

6. The traceability management data creation method according to claim 1, wherein
information accompanying a product is recorded in association with the product record of the product.

7. A traceability management data creation apparatus for creating data for management of traceability for identifying, from one product, products used for this one product as materials or parts and products using this one product as a material or a part, in a kanban production system in which, for each of unfinished products to be used for next-stage products as materials or parts and finished products, manufacture thereof is performed accompanied by a kanban used repeatedly and circularly for each of the products, the apparatus comprising:
a product record creation section that creates a product record including a product number of a product, a sequential number of a kanban accompanying the product, and a point in time of starting manufacture of the product, the product record being associated with one product or one group of the same kind of products; and
a link record creation section that creates a link record which associates the product record of an unfinished product and the product record of a next-stage product manufactured with the use of the unfinished product as a material or a part.

8. The traceability management data creation apparatus according to claim 7, comprising an accompanying information recording section that records information accompanying a product in association with the product record of the product.

9. A traceability management data creation program storage medium storing a traceability management data creation program that is executed in an information processor for executing programs and that causes the information processor to operate as a traceability management data creation apparatus for creating data for management of traceability for identifying, from one product, products used for this one product as materials or parts and products using this one product as a material or a part, in a kanban production system in which, for each of unfinished products to be used for the next-stage products as materials or parts and finished products, manufacture thereof is performed accompanied by a kanban used repeatedly and circularly for each of the products, the traceability management data creation program storage medium storing the traceability management data creation program that causes the information processor to operate as the traceability management data creation apparatus comprising:
a product record creation section that creates a product record including a product number of a product, a sequential number of a kanban accompanying the product, and a point in time of starting manufacture of the product, the product record being associated with one product or one group of the same kind of products; and
a link record creation section that creates a link record which associates the product record of an unfinished product and the product record of a next-stage product manufactured with the use of the unfinished product as a material or a part.

10. The traceability management data creation program storage medium according to claim 9, storing the traceability management data creation program that causes the information processor to operate as the traceability management data creation apparatus further comprising an accompanying information recording section that records information accompanying a product in association with the product record of the product.
